(19) United States
(12) Patent Application Publication
(10) Pub. No.: US 2026/0255248 A1
(43) Pub. Date: Aug. 27, 2026

(54) Communication Method and Apparatus

(71) Applicant: HUAWEI TECHNOLOGIES CO., LTD., Shenzhen (CN)

(72) Inventors: Yu Wang, Hangzhou (CN); Hejia Luo, Ottawa (CA); Jun Wang, Hangzhou (CN); Xiaolu Wang, Hangzhou (CN)

(73) Assignee: HUAWEI TECHNOLOGIES CO., LTD., Shenzhen (CN)

(21) Appl. No.: 19/648,617

(22) Filed: Apr. 15, 2026

Related U.S. Application Data
(63) Continuation of application No. PCT/CN2023/124731, filed on Oct. 16, 2023.

(51) Int. Cl. H04W 36/32; H04B 17/318; H04W 56/00; H04W 64/00; H04W 84/06

(52) U.S. Cl. CPC H04W 36/322; H04B 17/328; H04W 56/0015; H04W 64/00; H04W 84/06

(57) ABSTRACT

A terminal device receives first configuration information from a non-terrestrial network device, where the first configuration information includes a first condition; the terminal device determines location information and/or time information; and if it is determined, based on the location information and/or the time information, that at least one item of the first condition is met, the terminal device attempts to measure a reference signal in a coverage area of a terrestrial network device.

### CROSS-REFERENCE TO RELATED APPLICATIONS

This is a continuation of International Patent Application No. PCT/CN2023/124731 filed on Oct. 16, 023, which is hereby incorporated by reference in its entirety.

### TECHNICAL FIELD

This disclosure relates to the field of communication technologies, and in particular, to a communication method and apparatus.

### BACKGROUND

A non-terrestrial network (NTN) may include a satellite network, a high-altitude platform, an uncrewed aerial vehicle, and other nodes, offer significant advantages such as global coverage, long-distance transmission, flexible networking, convenient deployment, and independence from geographical constraints. NTN has been widely applied to a variety of fields such as maritime communication, positioning and navigation, disaster relief, scientific experiments, video broadcasting, and earth observation. A terrestrial network and the NTN may be mutually integrated, complement each other's strengths, and jointly form an integrated sea-land-air-space-ground ubiquitous communication network with seamless global coverage, thereby satisfying users' diverse ubiquitous service requirements.

In the NTN, movement of a satellite node may cause group handover or group reselection among users at a beam footprint within a specific zone. Using group handover as an example, as shown in FIG. 1, a user equipment (UE) cluster at a single beam footprint in a zone Zone-2 is UE-G1 (UE-G1 includes a plurality of UEs). Within time T1, UE-G1 is served by one or more beams of a satellite SAT-2. Within time T2, the satellite SAT-2 does not serve the beam footprint due to movement of the satellite SAT-2, and UE-G1 is served by one or more beams of a satellite SAT-1. Therefore, UE-G1 experiences group handover.

Therefore, in scenarios involving the integration of NTN and terrestrial networks, the movement of satellite nodes as well as the mobility of terminal devices makes it a key technical challenge for persons skilled in the art to enable terminals to efficiently determine when and where to perform measurement and/or handover, so as to reduce signaling overheads and measurement overheads.

### SUMMARY

This disclosure provides a communication method and apparatus, so that a terminal device can more efficiently determine a measurement occasion and/or a handover occasion, to improve a success rate of measurement and/or handover, thereby reducing signaling overheads and measurement overheads.

According to a first aspect, an embodiment of this disclosure provides a communication method. The method includes: a terminal device receives first configuration information from a non-terrestrial network device, where the first configuration information includes a first condition; the terminal device determines location information and/or time information; and if it is determined, based on the location information and/or the time information, that at least one item of the first condition is met, the terminal device attempts to measure a reference signal in a coverage area of a terrestrial network device.

In the foregoing method, in a satellite-ground integrated communication scenario, that is, in a scenario in which a non-terrestrial network and a terrestrial network are integrated, the terminal device determines, based on the location information and/or the time information, whether the first condition is met, and if the first condition is met, attempts to measure the reference signal in the coverage area of the terrestrial network device. In this manner, the terminal device can accurately determine when to perform measurement, that is, determine a measurement attempt occasion, so that measurement effectiveness and a measurement success rate can be improved, thereby reducing measurement overheads and signaling overheads.

In a possible implementation, the first condition includes one or more of the following items: a distance between the terminal device and a reference point in the coverage area of the terrestrial network device is less than a first threshold and greater than a second threshold; a distance between the terminal device and a reference point in the coverage area of the terrestrial network device gradually decreases; or a clock of the terminal device is within a first time period.

In another possible implementation, the method further includes: the terminal device receives second configuration information from the non-terrestrial network device, where the second configuration information includes a second condition; and if it is determined, based on the location information and/or the time information, that at least one item of the second condition is met, the terminal device determines to hand over from the non-terrestrial network device to the terrestrial network device.

In the foregoing method, in a satellite-ground integrated communication scenario, that is, in a scenario in which a non-terrestrial network and a terrestrial network are integrated, the terminal device determines, based on the location information and/or the time information, whether the second condition is met, and hands over from the non-terrestrial network device to the terrestrial network device if the second condition is met. In this manner, the terminal device can accurately determine when to perform handover, that is, determine a handover occasion, so that a handover success rate can be improved, thereby reducing signaling overheads.

In another possible implementation, the second condition includes one or more of the following items: the distance between the terminal device and the reference point in the coverage area of the terrestrial network device is less than the second threshold; the distance between the terminal device and the reference point in the coverage area of the terrestrial network device gradually decreases; signal quality of the terrestrial network device that is measured by the terminal device is greater than a third threshold; or the clock of the terminal device is within a second time period.

In another possible implementation, that the distance between the terminal device and the reference point in the coverage area of the terrestrial network device gradually decreases includes: a quantity of times that the distance between the terminal device and the reference point in the coverage area of the terrestrial network device decreases within preset time exceeds N, and/or an included angle between a speed direction of the terminal device and a connection line between the terminal device and the reference point in the coverage area of the terrestrial network device is less than 90 degrees, where N is a positive integer.

According to a second aspect, an embodiment of this disclosure provides a communication method. The method includes: a non-terrestrial network device determines first configuration information, where the first configuration information includes a first condition; and the non-terrestrial network device sends the first configuration information to a terminal device, where the first condition is used to measure a reference signal in a coverage area of a terrestrial network device.

In a possible implementation, the first condition includes one or more of the following items: a distance between the terminal device and a reference point in the coverage area of the terrestrial network device is less than a first threshold and greater than a second threshold; a distance between the terminal device and a reference point in the coverage area of the terrestrial network device gradually decreases; or a clock of the terminal device is within a first time period.

In another possible implementation, the method further includes: the non-terrestrial network device sends second configuration information to the terminal device, where the second configuration information includes a second condition, and the second condition is used by the terminal device to hand over from the non-terrestrial network device to the terrestrial network device.

In another possible implementation, the second condition includes one or more of the following items: the distance between the terminal device and the reference point in the coverage area of the terrestrial network device is less than the second threshold; the distance between the terminal device and the reference point in the coverage area of the terrestrial network device gradually decreases; signal quality of the terrestrial network device that is measured by the terminal device is greater than a third threshold; or the clock of the terminal device is within a second time period.

In another possible implementation, that the distance between the terminal device and the reference point in the coverage area of the terrestrial network device gradually decreases includes: a quantity of times that the distance between the terminal device and the reference point in the coverage area of the terrestrial network device decreases within preset time exceeds N, and/or an included angle between a speed direction of the terminal device and a connection line between the terminal device and the reference point in the coverage area of the terrestrial network device is less than 90 degrees, where N is a positive integer.

For technical effects brought by the second aspect or the possible implementations, refer to the descriptions of the technical effects of the first aspect or the possible implementations.

According to a third aspect, an embodiment of this disclosure provides a communication method. The method includes: a terminal device receives first configuration information from a terrestrial network device, where the first configuration information includes a first condition; the terminal device determines location information; and if it is determined, based on the location information, that at least one item of the first condition is met, the terminal device attempts to measure a reference signal in a coverage area of a non-terrestrial network device.

In the foregoing method, in a satellite-ground integrated communication scenario, that is, in a scenario in which a non-terrestrial network and a terrestrial network are integrated, the terminal device determines, based on the location information, whether the first condition is met, and if the first condition is met, attempts to measure the reference signal in the coverage area of the non-terrestrial network device. In this manner, the terminal device can accurately determine when to perform measurement, that is, determine a measurement attempt occasion, so that measurement effectiveness and a measurement success rate can be improved, thereby reducing measurement overheads and signaling overheads.

In a possible implementation, the first condition includes one or more of the following items: a distance between the terminal device and a reference point in a coverage area of the terrestrial network device is less than a first threshold and greater than a second threshold; or a distance between the terminal device and a reference point in a coverage area of the terrestrial network device gradually increases.

In another possible implementation, the method further includes: the terminal device receives second configuration information from the terrestrial network device, where the second configuration information includes a second condition; the terminal device determines time information; and if it is determined, based on the location information and/or the time information, that at least one item of the second condition is met, the terminal device determines to hand over from the terrestrial network device to the non-terrestrial network device.

In the foregoing method, in a satellite-ground integrated communication scenario, that is, in a scenario in which a non-terrestrial network and a terrestrial network are integrated, the terminal device determines, based on the location information and/or the time information, whether the second condition is met, and hands over from the terrestrial network device to the non-terrestrial network device if the second condition is met. In this manner, the terminal device can accurately determine when to perform handover, that is, determine a handover occasion, so that a handover success rate can be improved, thereby reducing signaling overheads.

In another possible implementation, the second condition includes one or more of the following items: a distance between the terminal device and a central point in the coverage area of the terrestrial network device is greater than the first threshold; a distance between the terminal device and a central point in the coverage area of the terrestrial network device gradually increases; a clock of the terminal device is within a first time period; or signal quality of the non-terrestrial network device that is measured by the terminal device is greater than a third threshold.

In another possible implementation, the method further includes: the terminal device receives the reference signal from the non-terrestrial network device, where the reference signal includes a handover synchronization signal block.

In another possible implementation, that the distance between the terminal device and the reference point in the coverage area of the terrestrial network device gradually increases includes: a quantity of times that the distance between the terminal device and the reference point in the coverage area of the terrestrial network device increases within preset time exceeds N, and/or an included angle between a speed direction of the terminal device and a connection line between the terminal device and the reference point in the coverage area of the terrestrial network device is greater than 90 degrees, where N is a positive integer.

In another possible implementation, the terminal device attempts to measure the reference signal in the coverage area of the non-terrestrial network device, and the method further includes: the terminal device receives synchronization signal block measurement timing configuration x (STMCx) information, where the STMCx information includes a periodicity of a measurement window and/or duration of the measurement window; and the terminal device attempts, based on the STMCx information, to measure the reference signal in the coverage area of the non-terrestrial network device.

According to a fourth aspect, an embodiment of this disclosure provides a communication method. The method includes: a terrestrial network device determines first configuration information, where the first configuration information includes a first condition; and the terrestrial network device sends the first configuration information to a terminal device, where the first condition is used to measure a reference signal in a coverage area of the terrestrial network device.

In a possible implementation, the first condition includes one or more of the following items: a distance between the terminal device and a reference point in the coverage area of the terrestrial network device is less than a first threshold and greater than a second threshold; or a distance between the terminal device and a reference point in the coverage area of the terrestrial network device gradually increases.

In another possible implementation, the method further includes: the terrestrial network device sends second configuration information to the terminal device, where the second configuration information includes a second condition, and the second condition is used by the terminal device to hand over from the terrestrial network device to a non-terrestrial network device.

In another possible implementation, the second condition includes one or more of the following items: a distance between the terminal device and a central point in the coverage area of the terrestrial network device is greater than the first threshold; a distance between the terminal device and a central point in the coverage area of the terrestrial network device gradually increases; a clock of the terminal device is within a first time period; or signal quality of the non-terrestrial network device that is measured by the terminal device is greater than a third threshold.

In another possible implementation, that the distance between the terminal device and the reference point in the coverage area of the terrestrial network device gradually increases includes:

A quantity of times that the distance between the terminal device and the reference point in the coverage area of the terrestrial network device increases within preset time exceeds N, and/or an included angle between a speed direction of the terminal device and a connection line between the terminal device and the reference point in the coverage area of the terrestrial network device is greater than 90 degrees, where N is a positive integer.

For technical effects brought by the fourth aspect or the possible implementations, refer to the descriptions of the technical effects of the third aspect or the possible implementations.

According to a fifth aspect, an embodiment of this disclosure provides a communication method. The method includes: a terminal device receives configuration information from a first network device, where the configuration information includes a first condition. The first condition includes one or more of the following items: a distance between the terminal device and a reference point in a coverage area of a terrestrial network device is less than a first threshold and greater than a second threshold, a distance between the terminal device and a reference point in a coverage area of a terrestrial network device is less than a second threshold, or a distance between the terminal device and a reference point in a coverage area of a terrestrial network device gradually decreases. A second condition includes: the distance between the terminal device and the reference point in the coverage area of the terrestrial network device is greater than the first threshold, the distance between the terminal device and the reference point in the coverage area of the terrestrial network device gradually increases, a clock of the terminal device is within a first time period, or signal quality measured by the terminal device is greater than a third threshold. The terminal device determines location information. If the location information meets at least one item of the first condition included in the configuration information, the terminal device sends a request message to the first network device, and determines to redirect from the first network device to a second network device, where the request message is used to request to release a radio resource control (RRC) link.

When the first network device is a non-terrestrial network device, and the second network device is a terrestrial network device, that the signal quality measured by the terminal device is greater than the third threshold may mean that signal quality of the terrestrial network device that is measured by the terminal device is greater than the third threshold. When the first network device is a terrestrial network device, and the second network device is a non-terrestrial network device, that the signal quality measured by the terminal device is greater than the third threshold may mean that signal quality of the non-terrestrial network device that is measured by the terminal device is greater than the third threshold.

In the foregoing method, in a satellite-ground integrated communication scenario, that is, in a scenario in which a non-terrestrial network and a terrestrial network are integrated, the terminal device determines, based on the location information, whether the first condition is met, and redirects from the first network device to the second network device if the first condition is met. In this manner, the terminal device can accurately determine when to perform redirection, that is, determine a redirection occasion, so that a probability of successful redirection is improved, and complexity of coordination between the non-terrestrial network and the terrestrial network device can be reduced, thereby reducing signaling overheads.

In a possible implementation, that the distance between the terminal device and the reference point in the coverage area of the terrestrial network device gradually decreases includes: a quantity of times that the distance between the terminal device and the reference point in the coverage area of the terrestrial network device decreases within preset time exceeds N, and/or an included angle between a speed direction of the terminal device and a connection line between the terminal device and the reference point in the coverage area of the terrestrial network device is less than 90 degrees, where N is a positive integer.

In another possible implementation, that the distance between the terminal device and the reference point in the coverage area of the terrestrial network device gradually increases includes: a quantity of times that the distance between the terminal device and the reference point in the coverage area of the terrestrial network device increases within preset time exceeds N, and/or an included angle between a speed direction of the terminal device and a connection line between the terminal device and the reference point in the coverage area of the terrestrial network device is greater than 90 degrees, where N is a positive integer.

According to a sixth aspect, an embodiment of this disclosure provides a communication method. The method includes: a first network device determines configuration information, where the configuration information includes a first condition. The first condition includes one or more of the following items: a distance between the terminal device and a reference point in a coverage area of a terrestrial network device is less than a first threshold and greater than a second threshold, a distance between the terminal device and a reference point in a coverage area of a terrestrial network device is less than a second threshold, a distance between the terminal device and a reference point in a coverage area of a terrestrial network device gradually decreases, a distance between the terminal device and a reference point in a coverage area of a terrestrial network device is greater than a first threshold, a distance between the terminal device and a reference point in a coverage area of a terrestrial network device gradually increases, a clock of the terminal device is within a first time period, or signal quality measured by the terminal device is greater than a third threshold. The first network device sends the configuration information to the terminal device, where the configuration information is used for redirection.

In another possible implementation, that the distance between the terminal device and the reference point in the coverage area of the terrestrial network device gradually decreases includes: a quantity of times that the distance between the terminal device and the reference point in the coverage area of the terrestrial network device decreases within preset time exceeds N, and/or an included angle between a speed direction of the terminal device and a connection line between the terminal device and the reference point in the coverage area of the terrestrial network device is less than 90 degrees, where N is a positive integer.

In another possible implementation, that the distance between the terminal device and the reference point in the coverage area of the terrestrial network device gradually increases includes: a quantity of times that the distance between the terminal device and the reference point in the coverage area of the terrestrial network device increases within preset time exceeds N, and/or an included angle between a speed direction of the terminal device and a connection line between the terminal device and the reference point in the coverage area of the terrestrial network device is greater than 90 degrees, where N is a positive integer.

For technical effects brought by the sixth aspect or the possible implementations, refer to the descriptions of the technical effects of the fifth aspect or the possible implementations.

According to a seventh aspect, an embodiment of this disclosure provides a communication apparatus. The communication apparatus may be a terminal device. Unless otherwise specified, the “terminal device” in this disclosure may be a terminal device, or may be a component (for example, a processor, a chip, or a chip system) in a terminal device, or may be a logical module or software that can implement all or some functions of a terminal device. The communication apparatus includes a processing unit and a communication unit. The communication unit is configured to receive first configuration information from a non-terrestrial network device, where the first configuration information includes a first condition; the processing unit is configured to determine location information and/or time information; and the processing unit is configured to: when it is determined, based on the location information and/or the time information, that at least one item of the first condition is met, attempt to measure a reference signal in a coverage area of a terrestrial network device.

In a possible implementation, the first condition includes one or more of the following items: a distance between the apparatus and a reference point in the coverage area of the terrestrial network device is less than a first threshold and greater than a second threshold; a distance between the apparatus and a reference point in the coverage area of the terrestrial network device gradually decreases; or a clock of the apparatus is within a first time period.

In another possible implementation, the communication unit is further configured to receive second configuration information from the non-terrestrial network device, where the second configuration information includes a second condition; and the processing unit is further configured to: when it is determined, based on the location information and/or the time information, that at least one item of the second condition is met, determine to hand over from the non-terrestrial network device to the terrestrial network device.

In another possible implementation, the second condition includes one or more of the following items: the distance between the apparatus and the reference point in the coverage area of the terrestrial network device is less than the second threshold; the distance between the apparatus and the reference point in the coverage area of the terrestrial network device gradually decreases; signal quality of the terrestrial network device that is measured by the apparatus is greater than a third threshold; or the clock of the apparatus is within a second time period.

In another possible implementation, that the distance between the apparatus and the reference point in the coverage area of the terrestrial network device gradually decreases includes: a quantity of times that the distance between the apparatus and the reference point in the coverage area of the terrestrial network device decreases within preset time exceeds N, and/or an included angle between a speed direction of the apparatus and a connection line between the apparatus and the reference point in the coverage area of the terrestrial network device is less than 90 degrees, where N is a positive integer.

For technical effects brought by the seventh aspect or the possible implementations, refer to the descriptions of the technical effects of the first aspect or the possible implementations.

According to an eighth aspect, an embodiment of this disclosure provides a communication apparatus. The communication apparatus may be a non-terrestrial network device. Unless otherwise specified, the “non-terrestrial network device” in this disclosure may be a non-terrestrial network device, or may be a component (for example, a processor, a chip, or a chip system) in a non-terrestrial network device, or may be a logical module or software that can implement all or some functions of a non-terrestrial network device. The communication apparatus includes a processing unit and a communication unit. The processing unit is configured to determine first configuration information, where the first configuration information includes a first condition; and the communication unit is configured to send the first configuration information to a terminal device, where the first condition is used to measure a reference signal in a coverage area of a terrestrial network device.

In a possible implementation, the first condition includes one or more of the following items: a distance between the terminal device and a reference point in the coverage area of the terrestrial network device is less than a first threshold and greater than a second threshold; a distance between the terminal device and a reference point in the coverage area of the terrestrial network device gradually decreases; or a clock of the terminal device is within a first time period.

In another possible implementation, the communication unit is further configured to send second configuration information to the terminal device, where the second configuration information includes a second condition, and the second condition is used by the terminal device to hand over from a non-terrestrial network device to the terrestrial network device.

In another possible implementation, the second condition includes one or more of the following items: the distance between the terminal device and the reference point in the coverage area of the terrestrial network device is less than the second threshold; the distance between the terminal device and the reference point in the coverage area of the terrestrial network device gradually decreases; signal quality of the terrestrial network device that is measured by the terminal device is greater than a third threshold; or the clock of the terminal device is within a second time period.

In another possible implementation, that the distance between the terminal device and the reference point in the coverage area of the terrestrial network device gradually decreases includes: a quantity of times that the distance between the terminal device and the reference point in the coverage area of the terrestrial network device decreases within preset time exceeds N, and/or an included angle between a speed direction of the terminal device and a connection line between the terminal device and the reference point in the coverage area of the terrestrial network device is less than 90 degrees, where N is a positive integer.

For technical effects brought by the eighth aspect or the possible implementations, refer to the descriptions of the technical effects of the second aspect or the possible implementations.

According to a ninth aspect, an embodiment of this disclosure provides a communication apparatus. The communication apparatus may be a terminal device. Unless otherwise specified, the “terminal device” in this disclosure may be a terminal device, or may be a component (for example, a processor, a chip, or a chip system) in a terminal device, or may be a logical module or software that can implement all or some functions of a terminal device. The communication apparatus includes a processing unit and a communication unit. The communication unit is configured to receive first configuration information from a terrestrial network device, where the first configuration information includes a first condition; the processing unit is configured to determine location information; and the processing unit is configured to: when it is determined, based on the location information, that at least one item of the first condition is met, attempt to measure a reference signal in a coverage area of a non-terrestrial network device.

In a possible implementation, the first condition includes one or more of the following items: a distance between the apparatus and a reference point in a coverage area of the terrestrial network device is less than a first threshold and greater than a second threshold; or a distance between the apparatus and a reference point in a coverage area of the terrestrial network device gradually increases.

In another possible implementation, the communication unit is further configured to receive second configuration information from the terrestrial network device, where the second configuration information includes a second condition; the processing unit is further configured to determine time information; and the processing unit is further configured to: when it is determined, based on the location information and/or the time information, that at least one item of the second condition is met, determine to hand over from the terrestrial network device to the non-terrestrial network device.

In another possible implementation, the second condition includes one or more of the following items: a distance between the apparatus and a central point in the coverage area of the terrestrial network device is greater than the first threshold; a distance between the apparatus and a central point in the coverage area of the terrestrial network device gradually increases; a clock of the apparatus is within a first time period; or signal quality of the non-terrestrial network device that is measured by the apparatus is greater than a third threshold.

In another possible implementation, the communication unit is further configured to receive the reference signal from the non-terrestrial network device, where the reference signal includes a handover synchronization signal block.

In another possible implementation, that the distance between the apparatus and the reference point in the coverage area of the terrestrial network device gradually increases includes: a quantity of times that the distance between the apparatus and the reference point in the coverage area of the terrestrial network device increases within preset time exceeds N, and/or an included angle between a speed direction of the apparatus and a connection line between the apparatus and the reference point in the coverage area of the terrestrial network device is greater than 90 degrees, where N is a positive integer.

In another possible implementation, the communication unit is further configured to receive STMCx information, where the STMCx information includes a periodicity of a measurement window and/or duration of the measurement window; and the processing unit is further configured to attempt, based on the STMCx information, to measure the reference signal in the coverage area of the non-terrestrial network device.

For technical effects brought by the ninth aspect or the possible implementations, refer to the descriptions of the technical effects of the third aspect or the possible implementations.

According to a tenth aspect, an embodiment of this disclosure provides a communication apparatus. The communication apparatus may be a terrestrial network device. Unless otherwise specified, the “terrestrial network device” in this disclosure may be a terrestrial network device, or may be a component (for example, a processor, a chip, or a chip system) in a terrestrial network device, or may be a logical module or software that can implement all or some functions of a terrestrial network device. The communication apparatus includes a processing unit and a communication unit. The processing unit is configured to determine first configuration information, where the first configuration information includes a first condition; and the communication unit is configured to send the first configuration information to a terminal device, where the first condition is used to measure a reference signal in a coverage area of the terrestrial network device.

In a possible implementation, the first condition includes one or more of the following items: a distance between the terminal device and a reference point in the coverage area of the terrestrial network device is less than a first threshold and greater than a second threshold; or a distance between the terminal device and a reference point in the coverage area of the terrestrial network device gradually increases.

In another possible implementation, the communication unit is further configured to send second configuration information to the terminal device, where the second configuration information includes a second condition, and the second condition is used by the terminal device to hand over from the terrestrial network device to a non-terrestrial network device.

In another possible implementation, the second condition includes one or more of the following items: a distance between the terminal device and a central point in the coverage area of the terrestrial network device is greater than the first threshold; a distance between the terminal device and a central point in the coverage area of the terrestrial network device gradually increases; a clock of the terminal device is within a first time period; or signal quality of the non-terrestrial network device that is measured by the terminal device is greater than a third threshold.

In another possible implementation, that the distance between the terminal device and the reference point in the coverage area of the terrestrial network device gradually increases includes: a quantity of times that the distance between the terminal device and the reference point in the coverage area of the terrestrial network device increases within preset time exceeds N, and/or an included angle between a speed direction of the terminal device and a connection line between the terminal device and the reference point in the coverage area of the terrestrial network device is greater than 90 degrees, where N is a positive integer.

For technical effects brought by the tenth aspect or the possible implementations, refer to the descriptions of the technical effects of the fourth aspect or the possible implementations.

According to an eleventh aspect, an embodiment of this disclosure provides a communication apparatus. The communication apparatus may be a terminal device. Unless otherwise specified, the “terminal device” in this disclosure may be a terminal device, or may be a component (for example, a processor, a chip, or a chip system) in a terminal device, or may be a logical module or software that can implement all or some functions of a terminal device. The communication apparatus includes a processing unit and a communication unit. The communication unit is configured to receive configuration information from a first network device, where the configuration information includes a first condition. The first condition includes one or more of the following items: a distance between the apparatus and a reference point in a coverage area of a terrestrial network device is less than a first threshold and greater than a second threshold, a distance between the apparatus and a reference point in a coverage area of a terrestrial network device is less than a second threshold, or a distance between the apparatus and a reference point in a coverage area of a terrestrial network device gradually decreases. A second condition includes: the distance between the apparatus and the reference point in the coverage area of the terrestrial network device is greater than the first threshold, the distance between the apparatus and the reference point in the coverage area of the terrestrial network device gradually increases, a clock of the apparatus is within a first time period, or signal quality measured by the apparatus is greater than a third threshold. The processing unit is configured to determine location information. The processing unit is configured to: when the location information meets at least one item of the first condition included in the configuration information, send a request message to the first network device, and determine to redirect from the first network device to a second network device, where the request message is used to request to release an RRC link.

In a possible implementation, that the distance between the apparatus and the reference point in the coverage area of the terrestrial network device gradually decreases includes: a quantity of times that the distance between the apparatus and the reference point in the coverage area of the terrestrial network device decreases within preset time exceeds N, and/or an included angle between a speed direction of the apparatus and a connection line between the apparatus and the reference point in the coverage area of the terrestrial network device is less than 90 degrees, where N is a positive integer.

In another possible implementation, that the distance between the apparatus and the reference point in the coverage area of the terrestrial network device gradually increases includes: a quantity of times that the distance between the apparatus and the reference point in the coverage area of the terrestrial network device increases within preset time exceeds N, and/or an included angle between a speed direction of the apparatus and a connection line between the apparatus and the reference point in the coverage area of the terrestrial network device is greater than 90 degrees, where N is a positive integer.

For technical effects brought by the eleventh aspect or the possible implementations, refer to the descriptions of the technical effects of the fifth aspect or the possible implementations.

According to a twelfth aspect, an embodiment of this disclosure provides a communication apparatus. The communication apparatus may be a first network device. Unless otherwise specified, the “first network device” in this disclosure may be a first network device, or may be a component (for example, a processor, a chip, or a chip system) in a first network device, or may be a logical module or software that can implement all or some functions of a first network device. The communication apparatus includes a processing unit and a communication unit. The processing unit is configured to determine configuration information, where the configuration information includes a first condition. The first condition includes one or more of the following items: a distance between the terminal device and a reference point in a coverage area of a terrestrial network device is less than a first threshold and greater than a second threshold, a distance between the terminal device and a reference point in a coverage area of a terrestrial network device is less than a second threshold, a distance between the terminal device and a reference point in a coverage area of a terrestrial network device gradually decreases, a distance between the terminal device and a reference point in a coverage area of a terrestrial network device is greater than a first threshold, a distance between the terminal device and a reference point in a coverage area of a terrestrial network device gradually increases, a clock of the terminal device is within a first time period, or signal quality measured by the terminal device is greater than a third threshold. The communication unit is configured to send the configuration information to the terminal device, where the configuration information is used for redirection.

In another possible implementation, that the distance between the terminal device and the reference point in the coverage area of the terrestrial network device gradually decreases includes: a quantity of times that the distance between the terminal device and the reference point in the coverage area of the terrestrial network device decreases within preset time exceeds N, and/or an included angle between a speed direction of the terminal device and a connection line between the terminal device and the reference point in the coverage area of the terrestrial network device is less than 90 degrees, where N is a positive integer.

In another possible implementation, that the distance between the terminal device and the reference point in the coverage area of the terrestrial network device gradually increases includes: a quantity of times that the distance between the terminal device and the reference point in the coverage area of the terrestrial network device increases within preset time exceeds N, and/or an included angle between a speed direction of the terminal device and a connection line between the terminal device and the reference point in the coverage area of the terrestrial network device is greater than 90 degrees, where N is a positive integer.

For technical effects brought by the twelfth aspect or the possible implementations, refer to the descriptions of the technical effects of the sixth aspect or the possible implementations.

According to a thirteenth aspect, an embodiment of this disclosure provides a communication apparatus. The communication apparatus includes at least one processor and a communication interface, and the at least one processor invokes a computer program or instructions stored in a memory to perform the method according to the first aspect or the possible implementations of the first aspect.

According to a fourteenth aspect, an embodiment of this disclosure provides a communication apparatus. The communication apparatus includes at least one processor and a communication interface, and the at least one processor invokes a computer program or instructions stored in a memory to perform the method according to the second aspect or the possible implementations of the second aspect.

According to a fifteenth aspect, an embodiment of this disclosure provides a communication apparatus. The communication apparatus includes at least one processor and a communication interface, and the at least one processor invokes a computer program or instructions stored in a memory to perform the method according to the third aspect or the possible implementations of the third aspect.

According to a sixteenth aspect, an embodiment of this disclosure provides a communication apparatus. The communication apparatus includes at least one processor and a communication interface, and the at least one processor invokes a computer program or instructions stored in a memory to perform the method according to the fourth aspect or the possible implementations of the fourth aspect.

According to a seventeenth aspect, an embodiment of this disclosure provides a communication apparatus. The communication apparatus includes at least one processor and a communication interface, and the at least one processor invokes a computer program or instructions stored in a memory to perform the method according to the fifth aspect or the possible implementations of the fifth aspect.

According to an eighteenth aspect, an embodiment of this disclosure provides a communication apparatus. The communication apparatus includes at least one processor and a communication interface, and the at least one processor invokes a computer program or instructions stored in a memory to perform the method according to the sixth aspect or the possible implementations of the sixth aspect.

According to a nineteenth aspect, an embodiment of this disclosure provides a chip apparatus. The chip apparatus includes at least one processor, and the at least one processor is configured to execute a computer program or instructions, to implement the method according to any one of the foregoing aspects.

According to a twentieth aspect, an embodiment of this disclosure provides a computer-readable storage medium. The computer-readable storage medium stores a computer program or instructions, and when the computer program or the instructions are run on a processor, the method according to any one of the foregoing aspects is implemented.

According to a twenty-first aspect, an embodiment of this disclosure provides a computer program product. The computer program product includes a computer program or instructions, and when the computer program or the instructions are run on a computer, the method according to any one of the foregoing aspects is implemented.

According to a twenty-second aspect, an embodiment of this disclosure provides a communication system. The communication system includes the apparatus according to the thirteenth aspect and the apparatus according to the fourteenth aspect, the apparatus according to the fifteenth aspect and the apparatus according to the sixteenth aspect, or the apparatus according to the seventeenth aspect and the apparatus according to the eighteenth aspect.

### BRIEF DESCRIPTION OF DRAWINGS

FIG. 1 is a diagram of terminal device group handover according to an embodiment of this disclosure;

FIG. 2 is a diagram of an architecture of a communication system according to an embodiment of this disclosure;

FIG. 3A and FIG. 3B are a diagram of a handover procedure in a terrestrial network according to an embodiment of this disclosure;

FIG. 4 is a diagram of an earth-moving system according to an embodiment of this disclosure;

FIG. 5 is a diagram of an earth-fixed system according to an embodiment of this disclosure;

FIG. 6 is a schematic flowchart of a communication method according to an embodiment of this disclosure;

FIG. 7 is a diagram of coverage areas of a non-terrestrial network device and a terrestrial network device according to an embodiment of this disclosure;

FIG. 8 is a diagram of a connection line between a speed direction and a reference point according to an embodiment of this disclosure;

FIG. 9 is a diagram of a measurement condition according to an embodiment of this disclosure;

FIG. 10 is a diagram of a handover condition according to an embodiment of this disclosure;

FIG. 11 is a schematic flowchart of another communication method according to an embodiment of this disclosure;

FIG. 12 is a diagram of a periodicity of a measurement window according to an embodiment of this disclosure;

FIG. 13 is a schematic flowchart of another communication method according to an embodiment of this disclosure;

FIG. 14 is a diagram of a structure of a communication apparatus according to an embodiment of this disclosure; and

FIG. 15 is a diagram of a structure of another communication apparatus according to an embodiment of this disclosure.

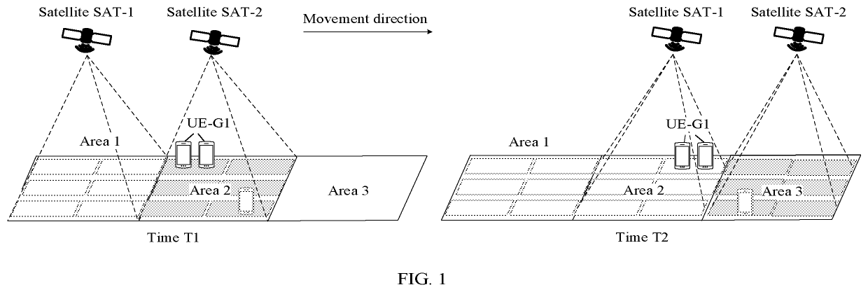

### DESCRIPTION OF EMBODIMENTS

The following clearly describes the technical solutions in embodiments of this disclosure with reference to the accompanying drawings in embodiments of this disclosure. It is clear that the described embodiments are merely some but not all of embodiments of this disclosure. Based on embodiments of this disclosure, all other embodiments obtained by persons skilled in the art without creative efforts fall within the protection scope of this disclosure.

Reference to “an embodiment”, “some embodiments”, or the like described in this disclosure indicates that one or more embodiments of this disclosure include a specific feature, structure, or characteristic described with reference to the embodiments. Therefore, statements such as “in an embodiment”, “in some embodiments”, “in some other embodiments”, and “in other embodiments” that appear at different places in this specification do not necessarily mean referring to a same embodiment. Instead, the statements mean “one or more but not all of embodiments”, unless otherwise emphasized in another manner. The terms “include”, “contain”, “have”, and variations thereof all mean “including but not limited to”, unless otherwise emphasized in another manner.

In descriptions of this disclosure, unless otherwise specified, “/” means “or”. For example, A/B may mean A or B. The term “and/or” in this specification is merely an association relationship of associated objects, and indicates that three relationships may exist. For example, A and/or B may indicate the following three cases: only A exists, both A and B exist, and only B exists. In addition, “at least one” means one or more, and “a plurality of” means two or more. “At least one of the following items (pieces)” or a similar expression thereof refers to any combination of these items, including a single item (piece) or any combination of a plurality of items (pieces). For example, at least one (piece) of a, b, or c may represent a, b, c, a and b, a and c, b and c, or a, b, and c. Herein, a, b, and c may be singular or plural.

It may be understood that, in this disclosure, an “indication” may include a direct indication, an indirect indication, an explicit indication, or an implicit indication. When a piece of indication information is described as indicating A, it may be understood that the indication information carries A, directly indicates A, or indirectly indicates A.

In this disclosure, information indicated by indication information is referred to as to-be-indicated information. In a specific implementation process, the to-be-indicated information is indicated in a plurality of manners. By way of example and not limitation, the to-be-indicated information may be directly indicated, for example, the to-be-indicated information or an index of the to-be-indicated information is indicated, or the to-be-indicated information may be indirectly indicated by indicating other information. There is an association relationship between the other information and the to-be-indicated information. Alternatively, only a part of the to-be-indicated information may be indicated, and the other part of the to-be-indicated information is known or pre-agreed on. For example, specific information may alternatively be indicated by using an arrangement sequence of a plurality of pieces of information that is pre-agreed on (for example, stipulated in a protocol), to reduce indication overheads to some extent.

The to-be-indicated information may be sent as a whole, or may be divided into a plurality of pieces of sub-information for separate sending. In addition, sending periods and/or sending occasions of the sub-information may be the same or may be different. A specific sending method is not limited in this disclosure. The sending periods and/or the sending occasions of the sub-information may be predefined, for example, predefined according to a protocol, or may be configured by a transmit end device by sending configuration information to a receive end device.

It may be understood that “sending” and “receiving” in this disclosure indicate a signal transfer direction. For example, “sending information to XX” may be understood as that a destination end of the information is XX, and may include direct sending through an air interface, or include indirect sending through an air interface by another unit or module. “Receiving information from YY” may be understood as that a source end of the information is YY, and may include direct receiving from YY through an air interface, or may include indirect receiving from YY via another unit or module through an air interface. “Sending” may alternatively be understood as “outputting” of a chip interface, and “receiving” may alternatively be understood as “inputting” of the chip interface.

In other words, sending and receiving may be performed between devices, for example, between a network device and a terminal device, or may be performed within a device. For example, sending or receiving is performed between components, modules, chips, software modules, or hardware modules in a device by using a bus, a cable, or an interface.

It may be understood that processing, for example, encoding and modulation, may be performed on information between a source end and a destination end of information sending, but the destination end may understand valid information from the source end. Similar expressions in this disclosure may be understood similarly. Details are not described again.

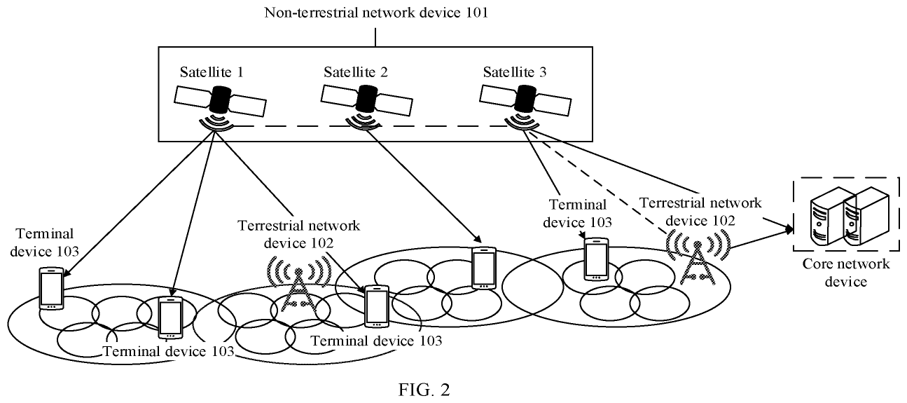

Refer to FIG. 2. FIG. 2 is a diagram of an architecture of a communication system according to an embodiment of this disclosure. The communication system architecture shown in FIG. 2 is used as an example to describe an application scenario used in this disclosure. The communication system includes a non-terrestrial network (NTN) device 101, a terrestrial network (TN) device 102, and a terminal device 103. The non-terrestrial network device 101 may be one or more satellites, for example, a satellite 1, a satellite 2, and a satellite 3. Each satellite may provide a communication service, a navigation service, a positioning service, and the like for the terminal device by using a plurality of beams. The satellite in this scenario is a low-Earth orbit (LEO) satellite, and the satellite 3 is connected to a terrestrial station device. The satellite uses a plurality of beams to cover a service zone, and different beams may be used to perform communication in one or more manners of time division, frequency division, and space division. The satellite performs wireless communication with the terminal device by using a broadcast communication signal, a navigation signal, and the like. The satellite may perform wireless communication with the terrestrial station device. The satellite mentioned in embodiments of this disclosure may be a satellite base station, may include an orbit receiver or a repeater configured to relay information, or may be a network side device mounted on the satellite. Satellites may be further classified into transparent transmission satellites and non-transparent transmission satellites. Transparent transmission is also referred to as bent-pipe forwarding transmission, that is, only processes such as frequency conversion and signal amplification are performed on a signal on a satellite, and the satellite is transparent for the signal and seems like nonexistent. Non-transparent transmission is also referred to as regenerative (on-satellite access/processing) transmission, that is, a satellite has some or all functions of a base station. For example, in the figure, the satellite 1 and the satellite 2 are non-transparent transmission satellites, and the satellite 3 is a transparent transmission satellite. In addition, the satellite may operate in three operating modes: an earth-fixed mode, a quasi-earth-fixed mode, or an earth-moving mode. The satellite in this disclosure may be a LEO satellite, a medium-Earth orbit satellite (MEO), or a geostationary Earth orbit satellite (GEO). This is not limited in embodiments of this disclosure. The method according to embodiments of this disclosure may be applied to the communication system shown in FIG. 2.

The terrestrial network device 102 is a device that is deployed in a radio access network (RAN) and that provides a wireless communication function for the terminal device. The terrestrial network device 102 may also be referred to as an access network (e.g., RAN) entity, an access node, a network node, a communication apparatus, or the like.

The terrestrial network device 102 may be an access network device in a cellular system related to the 3rd Generation Partnership Project (3GPP), for example, a 4th generation (4G) mobile communication system, a 5G mobile communication system, or a Beyond 5G mobile communication system. Alternatively, the terrestrial network device 102 may be an access network device in an open access network (Open RAN, O-RAN, or ORAN) or a cloud radio access network (C-RAN). Alternatively, the terrestrial network device 102 may be an access network device in a communication system obtained by integrating two or more of the foregoing communication systems.

The terrestrial network device 102 includes but is not limited to an evolved NodeB (eNB), a radio network controller (RNC), a NodeB (NB), a base station controller (BSC), a base transceiver station (BTS), a home base station (for example, a home evolved NodeB or a home NodeB (HNB)), a baseband unit (BBU), an access point (AP) in a WI-FI system, a macro base station, a micro base station, a wireless relay node, a donor node, a wireless controller in a CRAN scenario, a wireless backhaul node, a transmission point (TP), or a transmission and receiving point (TRP). The terrestrial network device 102 may alternatively be an access network device in a 5G mobile communication system, for example, a next generation NodeB (gNB), a TRP, or a TP in a New Radio (NR) system, or one antenna panel or a group of antenna panels (including a plurality of antenna panels) of a base station in a 5G mobile communication system. Alternatively, the terrestrial network device 102 may be a network node that forms a gNB or a transmission point, for example, a central unit (CU), a distributed unit (DU), a CU-control plane (CP), a CU-user plane (UP), or a radio unit (RU). The CU and the DU may be separately disposed, or may be included in a same network element, for example, a BBU. The RU may be included in a radio frequency device or a radio frequency unit, for example, in a remote radio unit (RRU), an active antenna unit (AAU), or a remote radio head (RRH). Alternatively, the terrestrial network device 102 may be a server, a wearable device, a vehicle, a vehicle-mounted device, or the like. For example, the terrestrial network device 102 may be a road side unit (RSU) in a vehicle-to-everything (V2X) technology.

It should be noted that in different systems, the CU (or the central unit-control plane (CU-CP) and the central unit-user plane (CU-UP)), the DU, or the RU may alternatively have different names, but persons skilled in the art may understand meanings thereof. For example, in an ORAN system, the CU may also be referred to as an open central unit (O-CU) or an open CU, the DU may also be referred to as an open distributed unit (O-DU), the CU-CP may also be referred to as an open central unit-control plane (O-CU-CP) or an open CU-CP, the CU-UP may also be referred to as an open central unit-user plane (O-CU-UP) or an open CU-UP, and the RU may also be referred to as an open radio unit (O-RU). This is not limited in this disclosure. Any unit in the CU, the CU-CP, the CU-UP, the DU, and the RU in this disclosure may be implemented by a software module, a hardware module, or a combination of the software module and the hardware module'.

In some deployments, the CU implements some functions of the gNB, and the DU implements some functions of the gNB. For example, the CU implements functions of an RRC layer and a Packet Data Convergence Protocol (PDCP) layer, and the DU implements functions of a radio link control (RLC) layer, a media access control (MAC) layer, and a physical layer (PHY). Information at the RRC layer eventually becomes information at the PHY layer, or is converted from information at the PHY layer. Therefore, in this architecture, higher layer signaling such as RRC layer signaling or PDCP layer signaling may also be considered as being sent by the DU or sent by the DU and the RU. It may be understood that the terrestrial network device 102 may be a CU node, a DU node, or a device including a CU node and a DU node. In addition, the CU may be classified as a network device in an access network RAN, or the CU may be classified as a network device in a core network (CN). This is not limited herein.

The terrestrial network device 102 may alternatively be a core network (CN) device, and the core network device is responsible for access control for a terminal device to access a network, registration management, service management, mobility management, and the like. The core network device includes, for example, an access and mobility management function (AMF) entity, a session management function (SMF) entity, a user plane function (UPF) entity, and the like, which are not listed one by one herein. The AMF entity may be responsible for access management and mobility management of a terminal. The SMF entity may be responsible for session management, for example, user session establishment. The UPF entity may be a function entity on a user plane, and is mainly responsible for connecting to an external network. It should be noted that, the entity in this disclosure may also be referred to as a network element or a function entity. For example, the AMF entity may also be referred to as an AMF network element or an AMF function entity. For another example, the SMF entity may also be referred to as an SMF network element or an SMF function entity.

It should be noted that the terrestrial network device may be a device or an apparatus with a chip, a device or an apparatus integrated with a circuit, or a chip, a module, or a control unit in the device or the apparatus shown above. This is not limited in this disclosure.

The terminal device 103 may also be referred to as UE, a mobile station (MS), a mobile terminal (MT), or the like, and is a device that provides voice or data connectivity for a user. The terminal device 103 includes a device that provides voice for a user, or includes a device that provides data connectivity for a user, or includes a device that provides voice and data connectivity for a user, for example, may include a handheld device with a wireless connection function, or a processing device connected to a wireless modem. The terminal device may communicate with a core network through a RAN, and exchange voice or data with the RAN, or exchange voice and data with the RAN. Currently, the terminal device may be a mobile phone, a tablet computer, a notebook computer, a palmtop computer, a mobile internet device (MID), a wearable device (for example, a smartwatch, a smart band, or a pedometer), a vehicle-mounted device (for example, an automobile, a bicycle, an electric vehicle, an airplane, a ship, a train, or a high-speed train), a virtual reality (VR) device, an augmented reality (AR) device, a wireless terminal in industrial control, a smart home device (for example, a refrigerator, a television, an air conditioner, or a meter), an intelligent robot, workshop equipment, a wireless terminal in self-driving, a wireless terminal in remote surgery, a wireless terminal in a smart grid, a wireless terminal in transportation safety, a wireless terminal in a smart city, a wireless terminal in a smart home, a flight device (for example, an intelligent robot, a hot air balloon, an uncrewed aerial vehicle, or an airplane), or the like. Alternatively, the terminal device may be another device that has a terminal function. For example, the terminal device may be a device that functions as a terminal in device-to-device (D2D) communication. The terminal device may alternatively include a V2X terminal device, a machine-to-machine (M2M)/machine-type communications (MTC) terminal device, an Internet of things (IoT) terminal device, a light terminal device (e.g., a light UE), reduced capability user equipment (REDCAP UE), a subscriber unit, a subscriber station, a mobile station, a remote station, an AP, a remote terminal, an access terminal, a user terminal, a user agent, a user device, an uncrewed aerial vehicle device, or the like. For example, the terminal device may include a mobile phone (or referred to as a “cellular” phone), a computer having a mobile terminal device, a portable, pocket-sized, handheld, or computer built-in mobile apparatus, or the like. For example, the terminal device may be a device such as a Personal Communication Service (PCS) phone, a cordless phone, a Session Initiation Protocol (SIP) phone, a wireless local loop (WLL) station, or a personal digital assistant (PDA). The terminal device may alternatively include a limited device, for example, a device with relatively low power consumption, a device with a limited storage capability, or a device with a limited computing capability. For example, the terminal device includes an information sensing device such as a barcode, radio frequency identification (RFID), a sensor, a Global Positioning System (GPS), or a laser scanner. A terminal device having wireless receiving and sending functions and a chip that can be disposed in the terminal device are collectively referred to as the terminal device in this disclosure.

It should be noted that the terminal device may be a device or an apparatus with a chip, a device or an apparatus integrated with a circuit, or a chip, a module, or a control unit in the device or the apparatus shown above. This is not limited in this disclosure.

The following describes some terms in this disclosure for ease of understanding.

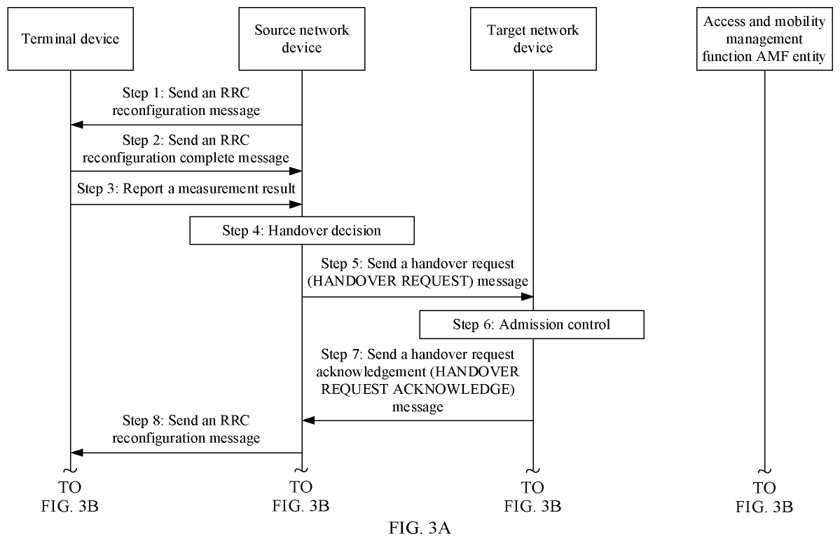

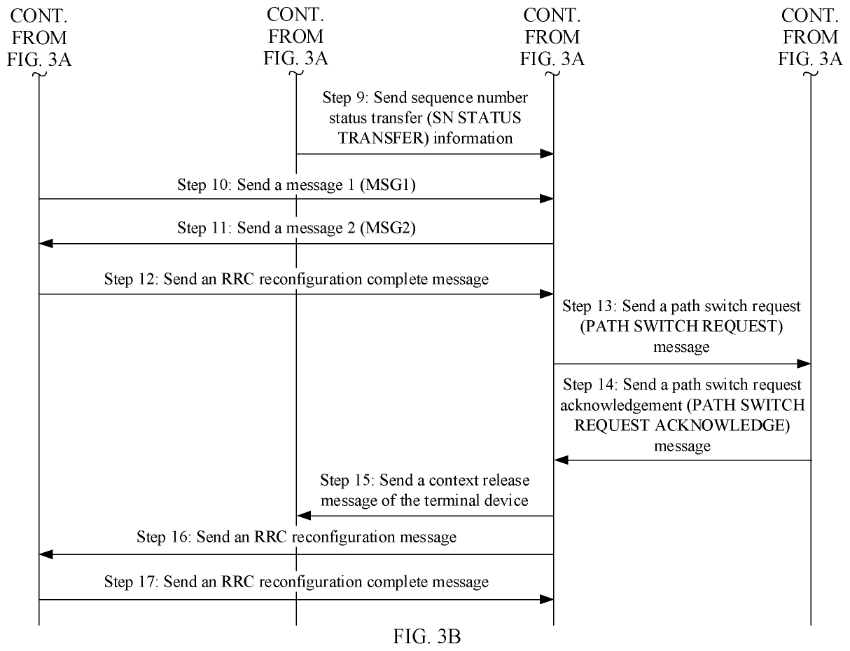

Mobility management of a terminal device mainly includes cell handover, cell reselection, registration update, tracking area update, and the like. Cell handover is used as an example. Refer to FIG. 3A and FIG. 3B. FIG. 3A and FIG. 3B are a diagram of a handover procedure in a terrestrial network according to an embodiment of this disclosure. The following operations are mainly included.
Step 1: A source network device sends an RRC reconfiguration message to a terminal device.

The RRC reconfiguration message includes a measurement configuration of a serving cell or a neighboring cell of the terminal device. Correspondingly, the terminal device may measure signal quality, for example, reference signal received power (RSRP) or reference signal received quality (RSRQ), of the cell based on the measurement configuration.
Step 2: The terminal device sends an RRC reconfiguration complete message to the source network device.
Step 3: The terminal device reports a measurement result to the source network device.

The terminal device may periodically send the measurement result to the source network device, or may send the measurement result to the source network device through event triggering. When the measurement result is sent to the source network device through event triggering, a reporting condition is usually configured as follows: signal quality of the serving cell is lower than a threshold 1 and/or signal quality of the neighboring cell is higher than a threshold 2.
Step 4: The source network device makes a handover decision.

It may be understood that the source network device selects an appropriate neighboring cell based on the measurement result, and exchanges information such as user handover related context information, admission control, or a reserved resource with a target network device.
Step 5: The source network device sends a handover request (HANDOVER REQUEST) message to the target network device.
Step 6: The target network device performs admission control.
Step 7: The target network device sends a handover request acknowledgement (HANDOVER REQUEST ACKNOWLEDGE) message to the source network device.
Step 8: The source network device sends an RRC reconfiguration message to the terminal device.
Step 9: The source network device sends sequence number (SN) status transfer information to the target network device.
Step 10: The terminal device sends a message 1 (MSG1) to the target network device.

The message 1 is used for random access.
Step 11: The target network device sends a message 2 (MSG2) to the terminal device.

The message 2 is a random-access response message.
Step 12: The terminal device sends an RRC reconfiguration complete message to the target network device.
Step 13: The target network device sends a path switch request (PATH SWITCH REQUEST) message to an AMF entity.
Step 14: The AMF entity sends a path switch request acknowledgement (PATH SWITCH REQUEST ACKNOWLEDGE) message to the target network device.
Step 15: The target network device sends a context release message of the terminal device to the source network device.
Step 16: The target network device sends an RRC reconfiguration message to the terminal device.
Step 17: The terminal device sends an RRC reconfiguration complete message to the target network device.

In the foregoing handover procedure, the terminal device receives handover related control information from the serving cell, and completes an access procedure in a new cell. A random-access preamble required by the terminal device during handover is a dedicated preamble, which is different from a contention-based random access preamble during initial access. In addition, a configuration supported by a time domain period of a random-access channel (RACH) during handover is 10/20/40/80/160 milliseconds (ms), which is the same as a RACH period configuration for initial access.

For cell reselection, a network device usually sends, to a terminal device in a broadcast form, a parameter such as a measurement configuration related to a neighboring cell. Correspondingly, the terminal device may compare a measurement value (for example, RSRP and RSRQ) of the terminal device with the parameter (for example, a reselection threshold) sent by the network device, and after a condition is met, the terminal device autonomously reselects to a target neighboring cell.

Using satellite communication as an example, according to operating modes of payloads (such as beams), satellite communication systems may be generally classified into an earth-moving satellite communication system and an earth-fixed satellite communication system. In the earth-moving satellite communication system, a satellite usually operates in an earth-moving mode. In the earth-fixed satellite communication system, a satellite usually operates in an earth-fixed mode or a quasi-earth-fixed mode.

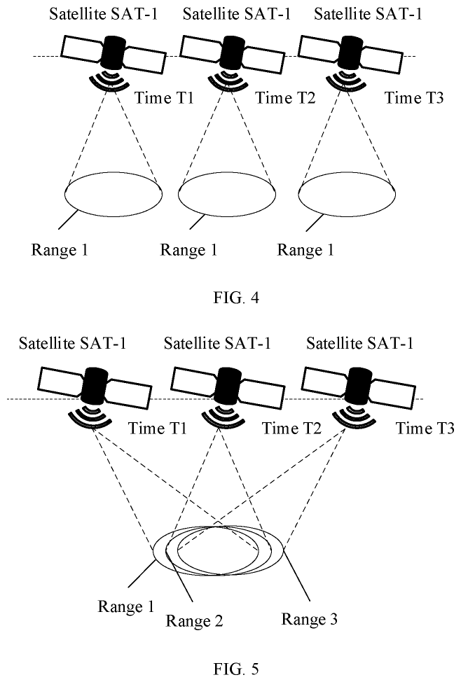

Earth-moving satellite communication system: In a period of time (such as time T1, T2, and T3), a beam coverage area of a satellite moves with the satellite. That is, in a period of time (such as time T1, T2, and T3), a coverage area of a beam or a cell of a satellite remains unchanged. Refer to FIG. 4. FIG. 4 is a diagram of an earth-moving system according to an embodiment of this disclosure. A satellite SAT-1 moves to a geographical location 1 within T1, and a coverage area of the satellite SAT-1 is a range 1; the satellite SAT-1 moves to a geographical location 2 within T2, and a coverage area of the satellite SAT-1 is the range 1; and the satellite SAT-1 moves to a geographical location 3 within T3, and a coverage area of the satellite SAT-1 is the range 1.

Earth-fixed satellite communication system: In a period of time (such as time T1, T2, and T3), a satellite dynamically adjusts a beam direction, so that a beam approximately covers a same area on the ground. That is, in a period of time (such as time T1, T2, and T3), a coverage area of a beam or a cell of a satellite moves with the satellite. Refer to FIG. 5. FIG. 5 is a diagram of an earth-fixed system according to an embodiment of this disclosure. A satellite SAT-1 moves to a geographical location 1 within T1, and a coverage area of the satellite SAT-1 is a range 1; the satellite SAT-1 moves to a geographical location 2 within T2, and a coverage area of the satellite SAT-1 is a range 2; and the satellite SAT-1 moves to a geographical location 3 within T3, and a coverage area of the satellite SAT-1 is a range 3.

Therefore, in a scenario in which an NTN and a terrestrial network are integrated, how to enable UE to efficiently determine when and where to perform measurement and/or handover to reduce signaling overheads and measurement overheads is a technical problem that is being resolved by persons skilled in the art. To resolve the foregoing problem, embodiments of this disclosure provide the following solutions.

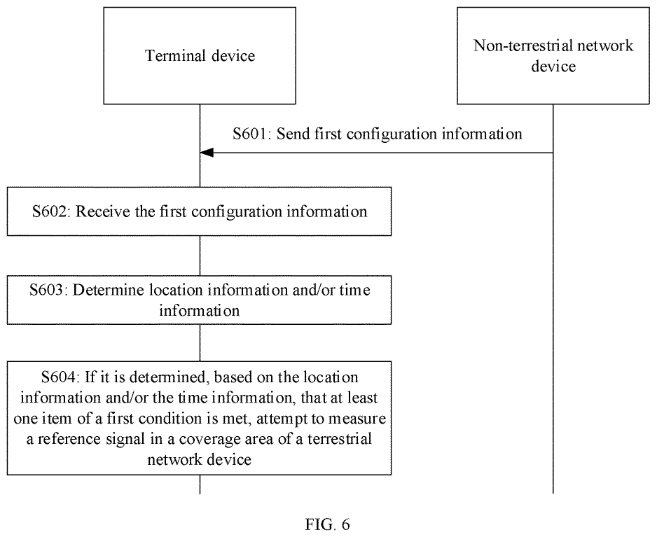

Refer to FIG. 6. FIG. 6 is a schematic flowchart of a communication method according to an embodiment of this disclosure. The method includes but is not limited to the following operations.
Step S601: A non-terrestrial network device sends first configuration information to a terminal device.
Step S602: The terminal device receives the first configuration information from the non-terrestrial network device.

The first configuration information includes a first condition, and the first condition includes one or more of the following items: a distance between the terminal device and a reference point in a coverage area of a terrestrial network device is less than a first threshold and greater than a second threshold; a distance between the terminal device and a reference point in a coverage area of a terrestrial network device gradually decreases; or a clock of the terminal device is within a first time period.

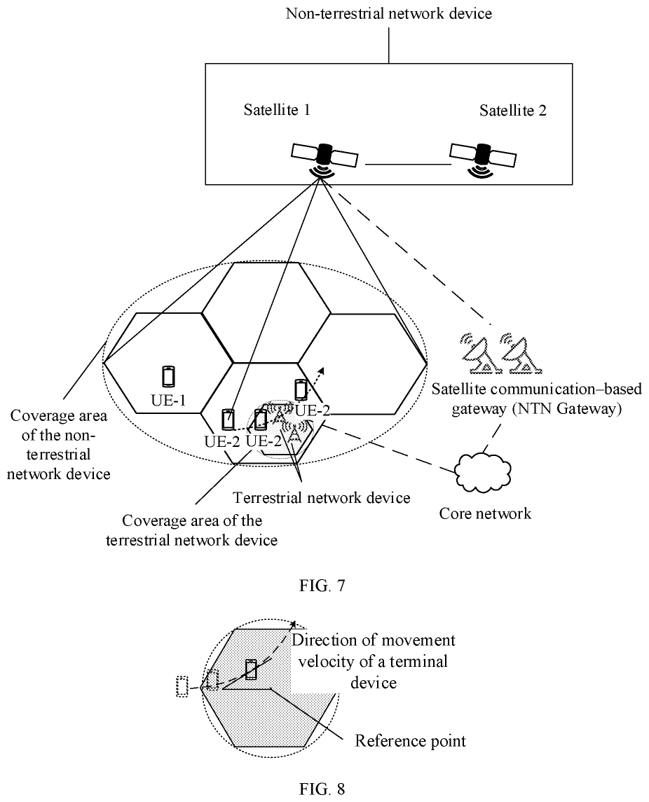

The coverage area of the terrestrial network device is physical space that can be covered by communication of the terrestrial network device, for example, may include a communication coverage area of one or more base stations. For example, the coverage area of the terrestrial network device may include a plurality of cells. Refer to FIG. 7. FIG. 7 is a diagram of coverage areas of a non-terrestrial network device and a terrestrial network device according to an embodiment of this disclosure. The reference point may include a central location point of the coverage area, a central location point of a beam, or any other location point. This is not limited in embodiments of this disclosure. The first threshold, the second threshold, and the first time period may be determined by the terminal device, specified in a protocol, or determined by the non-terrestrial network device. This is not limited in embodiments of this disclosure. That the clock of the terminal device is within the first time period may be understood as that current time displayed by the clock of the terminal device falls within the first time period, that is, within a first time range. For example, the first time period is [T1, T2], and the time displayed by the clock of the terminal device is T3, where the time T3 is within the first time period [T1, T2].

That the distance between the terminal device and the reference point in the coverage area of the terrestrial network device gradually decreases may mean that a quantity of times that the distance between the terminal device and the reference point in the coverage area of the terrestrial network device decreases within preset time exceeds N, and/or an included angle between a speed direction of the terminal device and a connection line between the terminal device and the reference point in the coverage area of the terrestrial network device is less than 90 degrees, where N is a positive integer. In an example, refer to FIG. 8. FIG. 8 is a diagram of a connection line between a speed direction and a reference point according to an embodiment of this disclosure. The preset time and/or N may be determined by the terminal device, specified in a protocol, or determined by the non-terrestrial network device.

Optionally, before the terminal device receives the first configuration information from the non-terrestrial network device, the non-terrestrial network device and the terrestrial network device may exchange related configuration information of coverage areas or service areas.

The non-terrestrial network device and the terrestrial network device may exchange the related configuration information of the coverage areas or the service areas by reusing an existing Xn interface or NG interface or using a newly defined interface.

The configuration information includes the reference point in the coverage area of the terrestrial network device and a threshold, and the threshold is a distance between a boundary range of the coverage area of the terrestrial network device and the reference point. For example, the configuration information includes TN_Area{ReferenceLocation, disThresh}, where ReferenceLocation represents the reference point in the coverage area of the terrestrial network device, and disThresh represents the threshold.
Step S603: The terminal device determines location information and/or time information.

The terminal device may determine the location information by using a global navigation satellite system (GNSS), and the location information may be an absolute location. The terminal device may determine the time information based on the clock of the terminal device, and the time information may be understood as current time displayed by the clock of the terminal device.
Step S604: If it is determined, based on the location information and/or the time information, that at least one item of the first condition is met, the terminal device attempts to measure a reference signal in the coverage area of the terrestrial network device.

The reference signal may include a broadcast signal, a channel state information reference signal (CSI-RS), a tracking reference signal (TRS), and/or another signal. For example, the broadcast signal may be a synchronization signal block (SSB).

That the terminal device attempts to measure the reference signal in the coverage area of the terrestrial network device if it is determined, based on the location information and/or the time information, that at least one item of the first condition is met may include one or more of the following items: if it is determined, based on the location information, that the distance between the terminal device and the reference point in the coverage area of the terrestrial network device is less than the first threshold and greater than the second threshold, the terminal device attempts to measure the reference signal in the coverage area of the terrestrial network device; if it is determined, based on the location information, that the distance between the terminal device and the reference point in the coverage area of the terrestrial network device gradually decreases, the terminal device attempts to measure the reference signal in the coverage area of the terrestrial network device; or if it is determined, based on the time information, that the clock of the terminal device is within the first time period, the terminal device attempts to measure the reference signal in the coverage area of the terrestrial network device.

The terminal device attempts to measure the reference signal in the coverage area of the terrestrial network device. If the terminal device obtains a measurement result by measuring the reference signal in the coverage area of the terrestrial network device, the measurement result may include RSRP and/or RSRQ. Optionally, the terminal device may send the measurement result to the non-terrestrial network device. Optionally, after the non-terrestrial network device receives the measurement result from the terminal device, the non-terrestrial network device may exchange user handover related information with the terrestrial network device. For example, the user handover related information may include terminal device handover context information, resource configuration information, and the like.

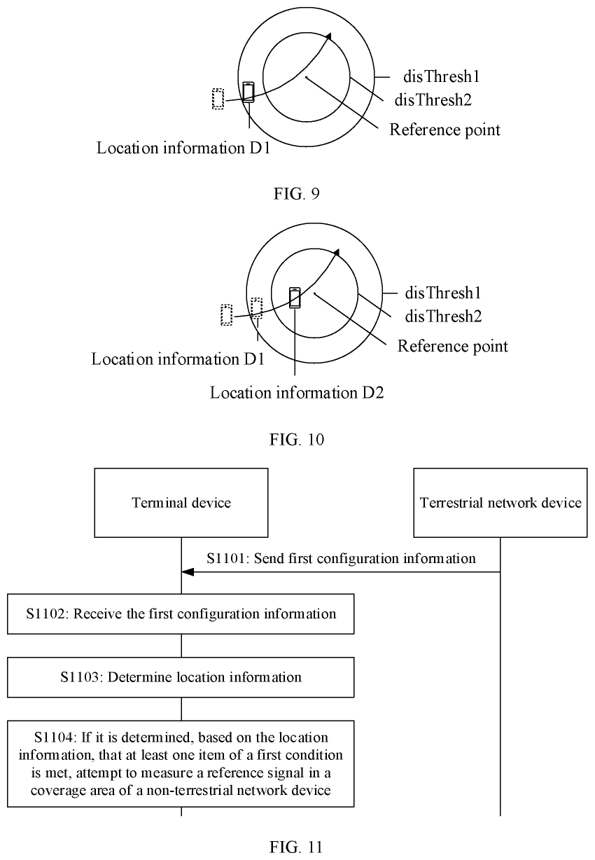

In an example, refer to FIG. 9. FIG. 9 is a diagram of a measurement condition according to an embodiment of this disclosure. The terminal device determines that the location information is D1. If it is determined, based on the location information, that the distance between the terminal device and the reference point in the coverage area of the terrestrial network device is less than the first threshold and greater than the second threshold, where the first threshold is disThresh, and the second threshold is disThresh2, the terminal device attempts to measure the reference signal in the coverage area of the terrestrial network device.

In the foregoing method, in a satellite-ground integrated communication scenario, that is, in a scenario in which a non-terrestrial network and a terrestrial network are integrated, the terminal device determines, based on the location information and/or the time information, whether the first condition is met, and if the first condition is met, attempts to measure the reference signal in the coverage area of the terrestrial network device. In this manner, the terminal device can accurately determine when to perform measurement, that is, determine a measurement attempt occasion, so that measurement effectiveness and a measurement success rate can be improved, thereby reducing measurement overheads and signaling overheads.

In a possible implementation, the terminal device receives second configuration information from the non-terrestrial network device, where the configuration information includes a second condition. If it is determined, based on the location information and/or the time information, that at least one item of the second condition is met, the terminal device determines to hand over from the non-terrestrial network device to the terrestrial network device.

Optionally, after the terminal device attempts to measure the reference signal in the coverage area of the terrestrial network device, if it is determined, based on the location information and/or the time information, that at least one item of the second condition is met, the terminal device determines to hand over from the non-terrestrial network device to the terrestrial network device.

The second condition includes one or more of the following items: the distance between the terminal device and the reference point in the coverage area of the terrestrial network device is less than the second threshold; the distance between the terminal device and the reference point in the coverage area of the terrestrial network device gradually decreases; signal quality of the terrestrial network device that is measured by the terminal device is greater than a third threshold; or the clock of the terminal device is within a second time period. That the clock of the terminal device is within the second time period may be understood as that current time displayed by the clock of the terminal device falls within the second time period, that is, within a second time range.

That the terminal device determines to hand over from the non-terrestrial network device to the terrestrial network device if it is determined, based on the location information and/or the time information, that at least one item of the second condition is met may include one or more of the following items: if it is determined, based on the location information, that the distance between the terminal device and the reference point in the coverage area of the terrestrial network device is less than the second threshold, the terminal device determines to hand over from the non-terrestrial network device to the terrestrial network device; if it is determined, based on the location information, that the distance between the terminal device and the reference point in the coverage area of the terrestrial network device gradually decreases, the terminal device determines to hand over from the non-terrestrial network device to the terrestrial network device; if the signal quality of the terrestrial network device that is measured by the terminal device is greater than the third threshold, the terminal device determines to hand over from the non-terrestrial network device to the terrestrial network device; or if it is determined, based on the time information, that the clock of the terminal device is within the second time period, the terminal device determines to hand over from the non-terrestrial network device to the terrestrial network device.

The third threshold and/or the second time period may be determined by the terminal device, specified in a protocol, or determined by the non-terrestrial network device. This is not limited in embodiments of this disclosure.

In an example, refer to FIG. 10. FIG. 10 is a diagram of a handover condition according to an embodiment of this disclosure. The terminal device determines that the location information is D2. If it is determined, based on the location information, that the distance between the terminal device and the reference point in the coverage area of the terrestrial network device is less than the second threshold, where the second threshold is disThresh2, the terminal device determines to hand over from the non-terrestrial network device to the terrestrial network device.

In the foregoing method, in a satellite-ground integrated communication scenario, that is, in a scenario in which a non-terrestrial network and a terrestrial network are integrated, the terminal device determines, based on the location information and/or the time information, whether the second condition is met, and hands over from the non-terrestrial network device to the terrestrial network device if the second condition is met. In this manner, the terminal device can accurately determine when to perform handover, that is, determine a handover occasion, so that a handover success rate can be improved, thereby reducing signaling overheads.

It should be noted that the terminal device may alternatively determine, when determining, based on the location information and/or the time information, that at least one item of the second condition is met and a handover trigger event based on signal quality is met, to hand over from the non-terrestrial network device to the terrestrial network device. The handover trigger event based on the signal quality may include: the signal quality obtained by the terminal device by measuring the terrestrial network device is greater than a fourth threshold, or the signal quality obtained by the terminal device by measuring the terrestrial network device is greater than a fourth threshold and signal quality obtained by the terminal device by measuring the non-terrestrial network device is less than a fifth threshold. The fourth threshold and the fifth threshold may be the same as or different from the third threshold. This is not limited in embodiments of this disclosure. The fourth threshold and the fifth threshold may be determined by the terminal device, specified in a protocol, or determined by the network device. This is not limited in embodiments of this disclosure.

In the method described in FIG. 6, in a satellite-ground integrated communication scenario, that is, in a scenario in which a non-terrestrial network and a terrestrial network are integrated, the terminal device determines, based on the location information and/or the time information, whether the first condition is met, and if the first condition is met, attempts to measure the reference signal in the coverage area of the terrestrial network device. In this manner, the terminal device can accurately determine when to perform measurement, that is, determine a measurement attempt occasion, so that measurement effectiveness and a measurement success rate can be improved, thereby reducing measurement overheads and signaling overheads.

Refer to FIG. 11. FIG. 11 is a schematic flowchart of another communication method according to an embodiment of this disclosure. The method includes but is not limited to the following operations.
Step S1101: A terrestrial network device sends first configuration information to a terminal device.
Step S1102: The terminal device receives the first configuration information from the terrestrial network device.

The first configuration information includes a first condition, and the first condition includes one or more of the following items: a distance between the terminal device and a reference point in a coverage area of the terrestrial network device is less than a first threshold and greater than a second threshold; or a distance between the terminal device and a reference point in a coverage area of the terrestrial network device gradually increases.

The coverage area of the terrestrial network device is physical space that can be covered by communication of the terrestrial network device, and the reference point may include a central point. For details, refer to the related descriptions in operation S602. Details are not described herein again. The first threshold, the second threshold, and a first time period may be determined by the terminal device, specified in a protocol, or determined by a non-terrestrial network device. This is not limited in embodiments of this disclosure.

That the distance between the terminal device and the reference point in the coverage area of the terrestrial network device gradually increases includes: a quantity of times that the distance between the terminal device and the reference point in the coverage area of the terrestrial network device increases within preset time exceeds N, and/or an included angle between a speed direction of the terminal device and a connection line between the terminal device and the reference point in the coverage area of the terrestrial network device is greater than 90 degrees, where N is a positive integer.

Optionally, before the terminal device receives the first configuration information from the terrestrial network device, the non-terrestrial network device and the terrestrial network device may exchange related configuration information of coverage areas or service areas. For details, refer to the related descriptions in operation S602. Details are not described herein again.

Optionally, after the terminal device receives the first configuration information from the terrestrial network device, the non-terrestrial network device may dynamically broadcast a reference signal. For example, the reference signal may include a handover synchronization signal block (HO-SSB). Correspondingly, the terminal device may receive the HO-SSB from the non-terrestrial network device.
Step S1103: The terminal device determines location information.

The terminal device may determine the location information by using a GNSS, and the location information may be an absolute location.
Step S1104: If it is determined, based on the location information, that at least one item of the first condition is met, the terminal device attempts to measure a reference signal in a coverage area of the non-terrestrial network device.

Optionally, the reference signal may include a broadcast signal and/or another signal. In an example, the reference signal may include an HO-SSB.

That the terminal device attempts to measure the reference signal in the coverage area of the non-terrestrial network device if it is determined, based on the location information, that at least one item of the first condition is met may include one or more of the following items: if it is determined, based on the location information, that the distance between the terminal device and the reference point in the coverage area of the terrestrial network device is less than the first threshold and greater than the second threshold, the terminal device attempts to measure the reference signal in the coverage area of the non-terrestrial network device; or if it is determined, based on the location information, that the distance between the terminal device and the reference point in the coverage area of the terrestrial network device gradually increases, the terminal device attempts to measure the reference signal in the coverage area of the non-terrestrial network device.

The terminal device attempts to measure the reference signal in the coverage area of the terrestrial network device. If the terminal device obtains a measurement result by measuring the reference signal in the coverage area of the terrestrial network device, the measurement result may include RSRP and/or RSRQ. Optionally, the terminal device may send the measurement result to the non-terrestrial network device.

The terminal device receives STMCx information, and the terminal device attempts, based on the STMCx information, to measure the reference signal in the coverage area of the non-terrestrial network device.

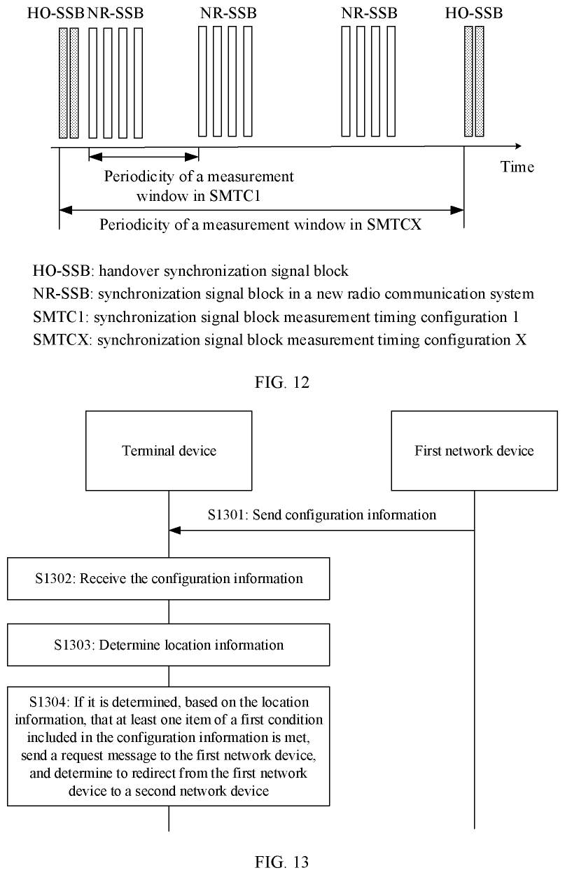

Optionally, the terminal device may receive the STMCx information from the terrestrial network device. The STMCx information includes a periodicity of a measurement window and/or duration of the measurement window. In other words, it may be understood that the period of the measurement window and/or the duration of the measurement window may be separately configured. Refer to FIG. 12. FIG. 12 is a diagram of a periodicity of a measurement window according to an embodiment of this disclosure. It can be learned from FIG. 12 that the period of the measurement window is greater than a periodicity of a measurement window in synchronization signal block measurement timing configuration 1 (STMC1) information, for example, may be dozens of seconds to hundreds of seconds. The duration may be dynamically scheduled/indicated, that is, is not limited to 1 ms to 5 ms. Correspondingly, a length of a measurement gap (GAP) is greater than a length of a measurement gap (GAP) in STMC1.

In the foregoing method, in a satellite-ground integrated communication scenario, that is, in a scenario in which a non-terrestrial network and a terrestrial network are integrated, the terminal device determines, based on the location information, whether the first condition is met, and if the first condition is met, attempts to measure the reference signal in the coverage area of the non-terrestrial network device. In this manner, the terminal device can accurately determine when to perform measurement, that is, determine a measurement attempt occasion, so that measurement effectiveness and a measurement success rate can be improved, thereby reducing measurement overheads and signaling overheads.

In a possible implementation, the terminal device receives second configuration information from the terrestrial network device, and the terminal device determines time information. If it is determined, based on the location information and/or the time information, that at least one item of a second condition is met, the terminal device determines to hand over from the terrestrial network device to the non-terrestrial network device.

Optionally, after the terminal device attempts to measure the reference signal in the coverage area of the non-terrestrial network device, if it is determined, based on the location information and/or the time information, that at least one item of the second condition is met, the terminal device determines to hand over from the terrestrial network device to the non-terrestrial network device.

The second configuration information includes the second condition, and the second condition includes one or more of the following items: a distance between the terminal device and a central point in the coverage area of the terrestrial network device is greater than the first threshold; a distance between the terminal device and a central point in the coverage area of the terrestrial network device gradually increases; a clock of the terminal device is within a first time period; or signal quality of the non-terrestrial network device that is measured by the terminal device is greater than a third threshold.

The terminal device may determine the time information based on the clock of the terminal device, and the time information may be understood as current time displayed by the clock of the terminal device.

That the terminal device determines to hand over from the terrestrial network device to the non-terrestrial network device if it is determined, based on the location information and/or the time information, that at least one item of the second condition is met may include: if it is determined, based on the location information, that the distance between the terminal device and the central point in the coverage area of the terrestrial network device is greater than the first threshold, the terminal device determines to hand over from the terrestrial network device to the non-terrestrial network device; if it is determined, based on the location information, that the distance between the terminal device and the central point in the coverage area of the terrestrial network device gradually increases, the terminal device determines to hand over from the terrestrial network device to the non-terrestrial network device; if it is determined, based on the time information, that the clock of the terminal device is within the first time period, the terminal device determines to hand over from the terrestrial network device to the non-terrestrial network device; or if it is determined that the signal quality of the non-terrestrial network device that is measured by the terminal device is greater than the third threshold, the terminal device determines to hand over from the terrestrial network device to the non-terrestrial network device.

In the foregoing method, in a satellite-ground integrated communication scenario, that is, in a scenario in which a non-terrestrial network and a terrestrial network are integrated, the terminal device determines, based on the location information and/or the time information, whether the second condition is met, and hands over from the terrestrial network device to the non-terrestrial network device if the second condition is met. In this manner, the terminal device can accurately determine when to perform handover, that is, determine a handover occasion, so that a handover success rate can be improved, thereby reducing signaling overheads.

It should be noted that the terminal device may alternatively determine, when determining, based on the location information and/or the time information, that at least one item of the second condition is met and a handover trigger event based on signal quality is met, to hand over from the terrestrial network device to the non-terrestrial network device. The handover trigger event based on the signal quality may include: the signal quality obtained by the terminal device by measuring the non-terrestrial network device is greater than a fourth threshold, or the signal quality obtained by the terminal device by measuring the non-terrestrial network device is greater than a fourth threshold and signal quality obtained by the terminal device by measuring the terrestrial network device is less than a fifth threshold. The fourth threshold and the fifth threshold may be the same as or different from the third threshold. This is not limited in embodiments of this disclosure. The fourth threshold and the fifth threshold may be determined by the terminal device, specified in a protocol, or determined by the network device. This is not limited in embodiments of this disclosure.

Optionally, after the terminal device receives the second configuration information from the terrestrial network device, the non-terrestrial network device may dynamically broadcast a reference signal. For example, the reference signal may include an HO-SSB. Correspondingly, the terminal device may receive the HO-SSB from the non-terrestrial network device.

Optionally, in a handover process of the terminal device, that is, in a process of handover from the terrestrial network device to the non-terrestrial network device, an access occasion (e.g., a random-access occasion (RO)) resource associated with the HO-SSB may be used.

In the method described in FIG. 11, in a satellite-ground integrated communication scenario, that is, in a scenario in which a non-terrestrial network and a terrestrial network are integrated, the terminal device determines, based on the location information, whether the first condition is met, and if the first condition is met, attempts to measure the reference signal in the coverage area of the non-terrestrial network device. In this manner, the terminal device can accurately determine when to perform measurement, that is, determine a measurement attempt occasion, so that measurement effectiveness and a measurement success rate can be improved, thereby reducing measurement overheads and signaling overheads.

Refer to FIG. 13. FIG. 13 is a schematic flowchart of another communication method according to an embodiment of this disclosure. The method includes but is not limited to the following operations.
Step S1301: A first network device sends configuration information to a terminal device.
Step S1302: The terminal device receives the configuration information from the first network device.

The configuration information includes a first condition, and the first condition includes: a distance between the terminal device and a reference point in a coverage area of a terrestrial network device is less than a first threshold and greater than a second threshold, a distance between the terminal device and a reference point in a coverage area of a terrestrial network device is less than a second threshold, a distance between the terminal device and a reference point in a coverage area of a terrestrial network device gradually decreases, a distance between the terminal device and a reference point in a coverage area of a terrestrial network device is greater than a first threshold, a distance between the terminal device and a reference point in a coverage area of a terrestrial network device gradually increases, a clock of the terminal device is within a first time period, or signal quality measured by the terminal device is greater than a third threshold.

The coverage area of the terrestrial network device is physical space that can be covered by communication of the terrestrial network device. The reference point may include a central location point of the coverage area, a central location point of a beam, or any other location point. This is not limited in embodiments of this disclosure. That the clock of the terminal device is within the first time period may be understood as that current time displayed by the clock of the terminal device falls within the first time period, that is, within a first time range. For details, refer to the related descriptions in operation S602. Details are not described herein again. The first threshold, the second threshold, the third threshold, and the first time period may be determined by the terminal device, specified in a protocol, or determined by the first network device. This is not limited in embodiments of this disclosure.

That the distance between the terminal device and the reference point in the coverage area of the terrestrial network device gradually decreases includes: a quantity of times that the distance between the terminal device and the reference point in the coverage area of the terrestrial network device decreases within preset time exceeds N, and/or an included angle between a speed direction of the terminal device and a connection line between the terminal device and the reference point in the coverage area of the terrestrial network device is less than 90 degrees, where N is a positive integer.

That the distance between the terminal device and the reference point in the coverage area of the terrestrial network device gradually increases includes: a quantity of times that the distance between the terminal device and the reference point in the coverage area of the terrestrial network device increases within preset time exceeds N, and/or an included angle between a speed direction of the terminal device and a connection line between the terminal device and the reference point in the coverage area of the terrestrial network device is greater than 90 degrees, where N is a positive integer.

Optionally, before the terminal device receives the configuration information from the first network device, the first network device and a second network device may exchange related configuration information of coverage areas or service areas. For details, refer to the related descriptions in operation S602. Details are not described herein again.
Step S1303: The terminal device determines location information.

The terminal device may determine the location information by using a GNSS, and the location information may be an absolute location.

The terminal device may further determine time information. For example, the terminal device may determine the time information based on the clock of the terminal device, and the time information may be understood as current time displayed by the clock of the terminal device.
Step S1304: If it is determined, based on the location information, that at least one item of the first condition included in the configuration information is met, the terminal device sends a request message to the first network device, and determines to redirect from the first network device to the second network device.

If at least one item of the first condition included in the configuration information is met based on the location information and/or the time information, the terminal device sends the request message to the first network device, and determines to redirect from the first network device to the second network device.

When the first network device is a non-terrestrial network device, the second network device is a terrestrial network device; or when the first network device is a terrestrial network device, the second network device is a non-terrestrial network device.

When the first network device is a non-terrestrial network device, and the second network device is a terrestrial network device, that the signal quality measured by the terminal device is greater than the third threshold may mean that signal quality of the terrestrial network device that is measured by the terminal device is greater than the third threshold. When the first network device is a terrestrial network device, and the second network device is a non-terrestrial network device, that the signal quality measured by the terminal device is greater than the third threshold may mean that signal quality of the non-terrestrial network device that is measured by the terminal device is greater than the third threshold.

The request message is used to request to release an RRC link.

In the method described in FIG. 13, in a satellite-ground integrated communication scenario, that is, in a scenario in which a non-terrestrial network and a terrestrial network are integrated, the terminal device determines, based on the location information, whether the first condition is met, and redirects from the first network device to the second network device if the first condition is met. In this manner, the terminal device can accurately determine when to perform redirection, that is, determine a redirection occasion, so that a probability of successful redirection is improved, and complexity of coordination between the non-terrestrial network and the terrestrial network device can be reduced, thereby reducing signaling overheads.

The foregoing describes in detail the method in embodiments of this disclosure. The following provides an apparatus in embodiments of this disclosure.

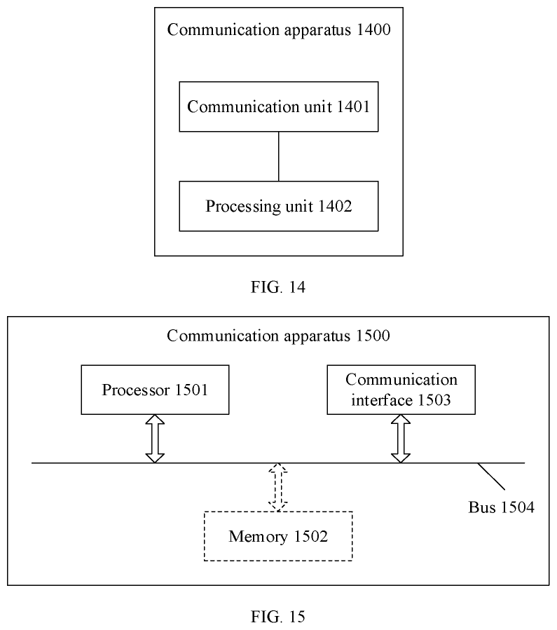

Refer to FIG. 14. FIG. 14 is a diagram of a structure of a communication apparatus 1400 according to an embodiment of this disclosure. The communication apparatus 1400 may include a communication unit 1401 and a processing unit 1402.

The communication apparatus 1400 may be a terminal device. Unless otherwise specified, the “terminal device” in this disclosure may be a terminal device, or may be a component (for example, a processor, a chip, or a chip system) in a terminal device, or may be a logical module or software that can implement all or some functions of a terminal device. Detailed descriptions of the units are as follows.

The communication unit 1401 is configured to receive first configuration information from a non-terrestrial network device, where the first configuration information includes a first condition.

The processing unit 1402 is configured to determine location information and/or time information.

The processing unit 1402 is configured to: when it is determined, based on the location information and/or the time information, that at least one item of the first condition is met, attempt to measure a reference signal in a coverage area of a terrestrial network device.

In a possible implementation, the first condition includes one or more of the following items: a distance between the apparatus and a reference point in the coverage area of the terrestrial network device is less than a first threshold and greater than a second threshold; a distance between the apparatus and a reference point in the coverage area of the terrestrial network device gradually decreases; or a clock of the apparatus is within a first time period.

In another possible implementation, the communication unit 1401 is further configured to receive second configuration information from the non-terrestrial network device, where the second configuration information includes a second condition; and the processing unit 1402 is further configured to: when it is determined, based on the location information and/or the time information, that at least one item of the second condition is met, determine to hand over from the non-terrestrial network device to the terrestrial network device.

In another possible implementation, the second condition includes one or more of the following items: the distance between the apparatus and the reference point in the coverage area of the terrestrial network device is less than the second threshold; the distance between the apparatus and the reference point in the coverage area of the terrestrial network device gradually decreases; signal quality of the terrestrial network device that is measured by the apparatus is greater than a third threshold; or the clock of the apparatus is within a second time period.

In another possible implementation, that the distance between the apparatus and the reference point in the coverage area of the terrestrial network device gradually decreases includes: a quantity of times that the distance between the apparatus and the reference point in the coverage area of the terrestrial network device decreases within preset time exceeds N, and/or an included angle between a speed direction of the apparatus and a connection line between the apparatus and the reference point in the coverage area of the terrestrial network device is less than 90 degrees, where N is a positive integer.

It should be noted that, for implementation and beneficial effects of the units, refer to the corresponding descriptions of the method embodiment shown in FIG. 6.

The communication apparatus 1400 may be a non-terrestrial network device. The “non-terrestrial network device” in this disclosure may be a non-terrestrial network device, or may be a component (for example, a processor, a chip, or a chip system) in a non-terrestrial network device, or may be a logical module or software that can implement all or some functions of a non-terrestrial network device. Detailed descriptions of the units are as follows.

The processing unit 1402 is configured to determine first configuration information, where the first configuration information includes a first condition; and the communication unit 1401 is configured to send the first configuration information to a terminal device, where the first condition is used to measure a reference signal in a coverage area of a terrestrial network device.

In a possible implementation, the first condition includes one or more of the following items: a distance between the terminal device and a reference point in the coverage area of the terrestrial network device is less than a first threshold and greater than a second threshold; a distance between the terminal device and a reference point in the coverage area of the terrestrial network device gradually decreases; or a clock of the terminal device is within a first time period.

In another possible implementation, the communication unit 1401 is further configured to send second configuration information to the terminal device, where the second configuration information includes a second condition, and the second condition is used by the terminal device to hand over from a non-terrestrial network device to the terrestrial network device.

In another possible implementation, the second condition includes one or more of the following items: the distance between the terminal device and the reference point in the coverage area of the terrestrial network device is less than the second threshold; the distance between the terminal device and the reference point in the coverage area of the terrestrial network device gradually decreases; signal quality of the terrestrial network device that is measured by the terminal device is greater than a third threshold; or the clock of the terminal device is within a second time period.

In another possible implementation, that the distance between the terminal device and the reference point in the coverage area of the terrestrial network device gradually decreases includes: a quantity of times that the distance between the terminal device and the reference point in the coverage area of the terrestrial network device decreases within preset time exceeds N, and/or an included angle between a speed direction of the terminal device and a connection line between the terminal device and the reference point in the coverage area of the terrestrial network device is less than 90 degrees, where N is a positive integer.

It should be noted that, for implementation and beneficial effects of the units, refer to the corresponding descriptions of the method embodiment shown in FIG. 6.

The communication apparatus 1400 may be a terminal device. Unless otherwise specified, the “terminal device” in this disclosure may be a terminal device, or may be a component (for example, a processor, a chip, or a chip system) in a terminal device, or may be a logical module or software that can implement all or some functions of a terminal device. Detailed descriptions of the units are as follows.

The communication unit 1401 is configured to receive first configuration information from a terrestrial network device, where the first configuration information includes a first condition; the processing unit 1402 is configured to determine location information; and the processing unit 1402 is configured to: when it is determined, based on the location information, that at least one item of the first condition is met, attempt to measure a reference signal in a coverage area of a non-terrestrial network device.

In a possible implementation, the first condition includes one or more of the following items: a distance between the apparatus and a reference point in a coverage area of the terrestrial network device is less than a first threshold and greater than a second threshold; or a distance between the apparatus and a reference point in a coverage area of the terrestrial network device gradually increases.

In another possible implementation, the communication unit 1401 is further configured to receive second configuration information from the terrestrial network device, where the second configuration information includes a second condition; the processing unit 1402 is further configured to determine time information; and the processing unit 1402 is further configured to: when it is determined, based on the location information and/or the time information, that at least one item of the second condition is met, determine to hand over from the terrestrial network device to the non-terrestrial network device.

In another possible implementation, the second condition includes one or more of the following items: a distance between the apparatus and a central point in the coverage area of the terrestrial network device is greater than the first threshold; a distance between the apparatus and a central point in the coverage area of the terrestrial network device gradually increases; a clock of the apparatus is within a first time period; or signal quality of the non-terrestrial network device that is measured by the apparatus is greater than a third threshold.

In another possible implementation, the communication unit 1401 is further configured to receive the reference signal from the non-terrestrial network device, where the reference signal includes a handover synchronization signal block.

In another possible implementation, that the distance between the apparatus and the reference point in the coverage area of the terrestrial network device gradually increases includes: a quantity of times that the distance between the apparatus and the reference point in the coverage area of the terrestrial network device increases within preset time exceeds N, and/or an included angle between a speed direction of the apparatus and a connection line between the apparatus and the reference point in the coverage area of the terrestrial network device is greater than 90 degrees, where N is a positive integer.

In another possible implementation, the communication unit 1401 is further configured to receive STMCx information, where the STMCx information includes a periodicity of a measurement window and/or duration of the measurement window; and the processing unit 1402 is further configured to attempt, based on the STMCx information, to measure the reference signal in the coverage area of the non-terrestrial network device.

It should be noted that, for implementation and beneficial effects of the units, refer to the corresponding descriptions of the method embodiment shown in FIG. 11.

The communication apparatus 1400 may be a terrestrial network device. Unless otherwise specified, the “terrestrial network device” in this disclosure may be a terrestrial network device, or may be a component (for example, a processor, a chip, or a chip system) in a terrestrial network device, or may be a logical module or software that can implement all or some functions of a terrestrial network device. Detailed descriptions of the units are as follows.

The processing unit 1402 is configured to determine first configuration information, where the first configuration information includes a first condition; and the communication unit 1401 is configured to send the first configuration information to a terminal device, where the first condition is used to measure a reference signal in a coverage area of a terrestrial network device.

In a possible implementation, the first condition includes one or more of the following items: a distance between the terminal device and a reference point in the coverage area of the terrestrial network device is less than a first threshold and greater than a second threshold; or a distance between the terminal device and a reference point in the coverage area of the terrestrial network device gradually increases.

In another possible implementation, the communication unit 1401 is further configured to send second configuration information to the terminal device, where the second configuration information includes a second condition, and the second condition is used by the terminal device to hand over from the terrestrial network device to a non-terrestrial network device.

In another possible implementation, the second condition includes one or more of the following items: a distance between the terminal device and a central point in the coverage area of the terrestrial network device is greater than the first threshold; a distance between the terminal device and a central point in the coverage area of the terrestrial network device gradually increases; a clock of the terminal device is within a first time period; or signal quality of the non-terrestrial network device that is measured by the terminal device is greater than a third threshold.

In another possible implementation, that the distance between the terminal device and the reference point in the coverage area of the terrestrial network device gradually increases includes: a quantity of times that the distance between the terminal device and the reference point in the coverage area of the terrestrial network device increases within preset time exceeds N, and/or an included angle between a speed direction of the terminal device and a connection line between the terminal device and the reference point in the coverage area of the terrestrial network device is greater than 90 degrees, where N is a positive integer.

It should be noted that, for implementation and beneficial effects of the units, refer to the corresponding descriptions of the method embodiment shown in FIG. 11.

The communication apparatus 1400 may be a terminal device. Unless otherwise specified, the “terminal device” in this disclosure may be a terminal device, or may be a component (for example, a processor, a chip, or a chip system) in a terminal device, or may be a logical module or software that can implement all or some functions of a terminal device. Detailed descriptions of the units are as follows.

The communication unit 1401 is configured to receive configuration information from a first network device, where the configuration information includes a first condition. The first condition includes one or more of the following items: a distance between the apparatus and a reference point in a coverage area of a terrestrial network device is less than a first threshold and greater than a second threshold, a distance between the apparatus and a reference point in a coverage area of a terrestrial network device is less than a second threshold, or a distance between the apparatus and a reference point in a coverage area of a terrestrial network device gradually decreases. A second condition includes: the distance between the apparatus and the reference point in the coverage area of the terrestrial network device is greater than the first threshold, the distance between the apparatus and the reference point in the coverage area of the terrestrial network device gradually increases, a clock of the apparatus is within a first time period, or signal quality measured by the apparatus is greater than a third threshold. The processing unit 1402 is configured to determine location information. The processing unit 1402 is configured to: when the location information meets at least one item of the first condition included in the configuration information, send a request message to the first network device, and determine to redirect from the first network device to a second network device, where the request message is used to request to release an RRC link.

In a possible implementation, that the distance between the apparatus and the reference point in the coverage area of the terrestrial network device gradually decreases includes: a quantity of times that the distance between the apparatus and the reference point in the coverage area of the terrestrial network device decreases within preset time exceeds N, and/or an included angle between a speed direction of the apparatus and a connection line between the apparatus and the reference point in the coverage area of the terrestrial network device is less than 90 degrees, where N is a positive integer.

In another possible implementation, that the distance between the apparatus and the reference point in the coverage area of the terrestrial network device gradually increases includes: a quantity of times that the distance between the apparatus and the reference point in the coverage area of the terrestrial network device increases within preset time exceeds N, and/or an included angle between a speed direction of the apparatus and a connection line between the apparatus and the reference point in the coverage area of the terrestrial network device is greater than 90 degrees, where N is a positive integer.

It should be noted that, for implementation and beneficial effects of the units, refer to the corresponding descriptions of the method embodiment shown in FIG. 13.

The communication apparatus 1400 may be a first network device. Unless otherwise specified, the “first network device” in this disclosure may be a first network device, or may be a component (for example, a processor, a chip, or a chip system) in a first network device, or may be a logical module or software that can implement all or some functions of a first network device. Detailed descriptions of the units are as follows.

The processing unit 1402 is configured to determine configuration information, where the configuration information includes a first condition. The first condition includes one or more of the following items: a distance between the terminal device and a reference point in a coverage area of a terrestrial network device is less than a first threshold and greater than a second threshold, a distance between the terminal device and a reference point in a coverage area of a terrestrial network device is less than a second threshold, a distance between the terminal device and a reference point in a coverage area of a terrestrial network device gradually decreases, a distance between the terminal device and a reference point in a coverage area of a terrestrial network device is greater than a first threshold, a distance between the terminal device and a reference point in a coverage area of a terrestrial network device gradually increases, a clock of the terminal device is within a first time period, or signal quality measured by the terminal device is greater than a third threshold. The communication unit 1401 is configured to send the configuration information to the terminal device, where the configuration information is used for redirection.

In another possible implementation, that the distance between the terminal device and the reference point in the coverage area of the terrestrial network device gradually decreases includes: a quantity of times that the distance between the terminal device and the reference point in the coverage area of the terrestrial network device decreases within preset time exceeds N, and/or an included angle between a speed direction of the terminal device and a connection line between the terminal device and the reference point in the coverage area of the terrestrial network device is less than 90 degrees, where N is a positive integer.

In another possible implementation, that the distance between the terminal device and the reference point in the coverage area of the terrestrial network device gradually increases includes: a quantity of times that the distance between the terminal device and the reference point in the coverage area of the terrestrial network device increases within preset time exceeds N, and/or an included angle between a speed direction of the terminal device and a connection line between the terminal device and the reference point in the coverage area of the terrestrial network device is greater than 90 degrees, where N is a positive integer.

It should be noted that, for implementation and beneficial effects of the units, refer to the corresponding descriptions of the method embodiment shown in FIG. 13.

Refer to FIG. 15. FIG. 15 is a diagram of a structure of another communication apparatus 1500 according to an embodiment of this disclosure. The communication apparatus 1500 includes at least one processor 1501 and a communication interface 1503, and optionally, further includes a memory 1502. The processor 1501, the memory 1502, and the communication interface 1503 are connected to each other through a bus 1504. Optionally, the memory 1502 may alternatively be integrated with the processor 1501.

The memory 1502 includes but is not limited to a random-access memory (RAM), a read-only memory (ROM), an erasable programmable read-only memory (EPROM), or a compact disc read-only memory (CD-ROM). The memory 1502 is configured to store related computer programs and data. The communication interface 1503 is configured to receive and send data.

The processor 1501 may be one or more central processing units (CPU). When the processor 1501 is one CPU, the CPU may be a single-core CPU, or may be a multi-core CPU.

The processor 1501 in the communication apparatus 1500 is configured to read a computer program or instructions stored in the memory 1502 to implement a function of the foregoing processing unit. The communication interface 1503 in the communication apparatus 1500 is configured to implement a function of the foregoing communication unit.

An embodiment of this disclosure further provides a chip apparatus. The chip apparatus includes at least one processor, and the at least one processor is configured to invoke a computer program or instructions stored in a memory, so that the processor performs the method provided in the embodiment shown in FIG. 6, FIG. 11, or FIG. 13.

An embodiment of this disclosure further provides a computer-readable storage medium. The computer-readable storage medium stores a computer program or instructions. When the computer program or the instructions are run on a processor, the method performed by the terminal device, the terrestrial network device, or the non-terrestrial network device in the foregoing method embodiments is implemented.

An embodiment of this disclosure further provides a computer program product. The computer program product includes a computer program or instructions. When the computer program or the instructions are run on a processor, the method performed by the terminal device, the terrestrial network device, or the non-terrestrial network device in the foregoing method embodiments is implemented.

An embodiment of this disclosure further provides a communication system. The communication system includes the terminal device in the foregoing embodiments and the non-terrestrial network device in the foregoing embodiments, the terminal device in the foregoing embodiments and the terrestrial network device in the foregoing embodiments, or the terminal device in the foregoing embodiments and the first network device in the foregoing embodiments. The terminal device is configured to perform some or all operations performed by the terminal device in the foregoing method embodiments, the non-terrestrial network device is configured to perform some or all operations of the non-terrestrial network device in the foregoing method embodiments, the terrestrial network device is configured to perform some or all operations of the terrestrial network device in the foregoing method embodiments, and the first network device is configured to perform some or all operations of the first network device in the foregoing method embodiments.

It may be understood that, the processor in embodiments of this disclosure may be a CPU, or may be another general-purpose processor, a digital signal processor (DSP), an application-specific integrated circuit (ASIC), a field-programmable gate array (FPGA) or another programmable logic device, a transistor logic device, a hardware component, or any combination thereof. The general-purpose processor may be a microprocessor, or may be any other processor or the like.

The method operations in embodiments of this disclosure may be implemented in a hardware manner, or may be implemented in a manner of executing software instructions by the processor. The software instructions may include a corresponding software module. The software module may be stored in a RAM, a flash memory, a ROM, a programmable read-only memory (PROM), an erasable programmable read-only memory, an electrically erasable programmable read-only memory (EEPROM), a register, a hard disk, a removable hard disk, a compact-disc read-only memory (CD-ROM), or any other form of storage medium well-known in the art. An example storage medium is coupled to a processor, so that the processor can read information from the storage medium and can write information into the storage medium. Certainly, the storage medium may alternatively be a part of the processor. The processor and the storage medium may be located in an ASIC. In addition, the ASIC may be located in a base station or a terminal. Certainly, the processor and the storage medium may exist in the base station or the terminal as discrete components.

All or some of the foregoing embodiments may be implemented by software, hardware, firmware, or any combination thereof. When software is used to implement the embodiments, all or some of the embodiments may be implemented in a form of a computer program product. The computer program product includes one or more computer programs or instructions. When the computer programs or the instructions are loaded and executed on a computer, all or some of the procedures or functions in embodiments of this disclosure are executed. The computer may be a general-purpose computer, a dedicated computer, a computer network, a network device, UE, or another programmable apparatus. The computer programs or the instructions may be stored in a computer-readable storage medium or may be transmitted from a computer-readable storage medium to another computer-readable storage medium. For example, the computer programs or the instructions may be transmitted from a website, computer, server, or data center to another website, computer, server, or data center in a wired or wireless manner. The computer-readable storage medium may be any usable medium accessible by a computer, or a data storage device such as a server or a data center integrating one or more usable media. The usable medium may be a magnetic medium, for example, a floppy disk, a hard disk drive, or a magnetic tape; or may be an optical medium, for example, a digital video disc; or may be a semiconductor medium, for example, a solid-state drive. The computer-readable storage medium may be a volatile or non-volatile storage medium, or may include two types of storage media: a volatile storage medium and a non-volatile storage medium.

In embodiments of this disclosure, unless otherwise stated or there is a logic conflict, terms and/or descriptions between different embodiments are consistent and may be mutually referenced, and technical features in different embodiments may be combined into a new embodiment based on an internal logical relationship thereof.

In the descriptions of this disclosure, the words such as “first”, “second”, “S601”, or “S602” are merely used for differentiated description and convenient context writing. Different sequence numbers do not have specific technical meanings, and cannot be understood as indicating or implying relative importance, or indicating or implying an execution sequence of operations. Execution sequences of the processes should be determined based on functions and internal logic of the processes.

The term “and/or” in this disclosure describes only an association relationship between associated objects, and represents that three relationships may exist. For example, “A and/or B” may represent the following three cases: only A exists, both A and B exist, and only B exists. A and B may be singular or plural. In addition, the character “/” in this specification indicates an “or” relationship between the associated objects.

In this disclosure, “transmission” may include the following three cases: data sending, data receiving, or data sending and data receiving. In this disclosure, “data” may include service data and/or signaling data.

In this disclosure, the terms “include” or “have” and any variation thereof are intended to cover non-exclusive inclusion. For example, a process/method that includes a series of operations or a system/product/device that includes a series of units is not necessarily limited to those expressly listed operations or units, but may include other operations or units not expressly listed or inherent to the process/method/product/device.

In the descriptions of this disclosure, unless otherwise specified, a quantity of nouns means “a singular noun or a plural noun”, that is, “one or more”. “At least one” means one or more. “Including at least one of the following: A, B, and C” means that A may be included, B may be included, C may be included, A and B may be included, A and C may be included, B and C may be included, or A, B, and C may be included. A, B, and C may be singular or plural.

1. A method performed by a communication apparatus, the method comprising:
receiving, from a terrestrial network (TN) device, first configuration information comprising a first condition, wherein the first condition comprises:
a first distance between the communication apparatus and a reference point in a first coverage area of the TN device is less than a first threshold and greater than a second threshold; or
the first distance gradually increases;
determining location information; and
attempting to measure a reference signal in a second coverage area of a non-terrestrial network (NTN) device when at least one item of the first condition is met based on the location information.

2. The method of claim 1, further comprising:
receiving, from the TN device, second configuration information comprising a second condition, wherein the second condition comprises one or more of:
a second distance between the communication apparatus and a central point in the first coverage area is greater than the first threshold;
the second distance gradually increases;
a clock of the communication apparatus is within a first time period; or
signal quality that is of the NTN device and that is measured by the communication apparatus is greater than a third threshold;
determining time information; and
determining to hand over from the TN device to the NTN device when at least one item of the second condition is met based on at least one of the location information or the time information.

3. The method of claim 1, further comprising receiving, from the NTN device, the reference signal, wherein the reference signal comprises a handover synchronization signal block (HO-SSB).

4. The method of claim 1, wherein the first distance device gradually increases when:
a quantity of times that the first distance increases within a preset time exceeds N, wherein N is a positive integer; or
an included angle between a speed direction of the communication apparatus and a connection line between the communication apparatus and the reference point in the first coverage area is greater than 90 degrees.

5. The method of claim 1, wherein attempting to measure the reference signal comprises:
receiving synchronization signal block measurement timing configuration (STMCx) information, wherein the STMCx information comprises a periodicity of a measurement window or a duration of the measurement window; and
attempting, based on the STMCx information, to measure the reference signal.

6. A communication apparatus, comprising:
a memory configured to store instructions; and
at least one processor coupled to the memory and configured to execute the instructions to cause the communication apparatus to:
receive, from a terrestrial network (TN) device, first configuration information comprising a first condition, wherein the first condition comprises:
a first distance between the communication apparatus and a reference point in a first coverage area of the TN device is less than a first threshold and greater than a second threshold; or
the first distance gradually increases;
determine location information; and
attempt to measure a reference signal in a second coverage area of a non-terrestrial network (NTN) device when at least one item of the first condition is met based on the location information.

7. The communication apparatus of claim 6, wherein the at least one processor is further configured to execute the instructions to cause the communication apparatus to:
receive, from the TN device, second configuration information comprising a second condition, wherein the second condition comprises one or more of:
a second distance between the communication apparatus and a central point in the first coverage area is greater than the first threshold;
the second distance gradually increases;
a clock of the communication apparatus is within a first time period; or
signal quality that is of the NTN device and that is measured by the communication apparatus is greater than a third threshold;
determine time information; and
determine to hand over from the TN device to the NTN device when at least one item of the second condition is met based on at least one of the location information or the time information.

8. The communication apparatus of claim 6, wherein the at least one processor is further configured to execute the instructions to cause the communication apparatus to receive, from the NTN device, the reference signal, wherein the reference signal comprises a handover synchronization signal block (HO-SSB).

9. The communication apparatus of claim 6, wherein the first distance gradually increases when:
a quantity of times that the first distance increases within a preset time exceeds N, wherein N is a positive integer; or
an included angle between a speed direction of the communication apparatus and a connection line between the communication apparatus and the reference point in the first coverage area is greater than 90 degrees.

10. The communication apparatus of claim 6, wherein the at least one processor is further configured to execute the instructions to cause the communication apparatus to further attempt to measure the reference signal by:
receiving synchronization signal block measurement timing configuration (STMCx) information, wherein the STMCx information comprises a periodicity of a measurement window or a duration of the measurement window; and
attempting, based on the STMCx information, to measure the reference signal.

11. A computer program product comprising instructions that are stored on a non-transitory computer-readable storage medium and that, when executed by at least one processor, cause a communication apparatus to:
receive, from a terrestrial network (TN) device, first configuration information comprising a first condition, wherein the first condition comprises:
a first distance between the communication apparatus and a reference point in a first coverage area of the TN device is less than a first threshold and greater than a second threshold; or
the first distance gradually increases;
determine location information; and
attempt to measure a reference signal in a second coverage area of a non-terrestrial network (NTN) device when at least one item of the first condition is met based on the location information.

12. The computer program product of claim 11, wherein the instructions, when executed by the at least one processor, further cause the communication apparatus to:
receive, from the TN device, second configuration information comprising a second condition, wherein the second condition comprises one or more of:
a second distance between the communication apparatus and a central point in the first coverage area is greater than the first threshold;
the second distance gradually increases;
a clock of the communication apparatus is within a first time period; or
signal quality that is of the NTN device and that is measured by the communication apparatus is greater than a third threshold;
determine time information; and
determine to hand over from the TN device to the NTN device when at least one item of the second condition is met based on at least one of the location information or the time information.

13. The computer program product of claim 11, wherein the instructions, when executed by the at least one processor, further cause the communication apparatus to receive, from the NTN device, the reference signal, and wherein the reference signal comprises a handover synchronization signal block (HO-SSB).

14. The computer program product of claim 11, wherein the first distance gradually increases when:
a quantity of times that the first distance increases within a preset time exceeds N, wherein N is a positive integer; or
an included angle between a speed direction of the communication apparatus and a connection line between the communication apparatus and the reference point in the first coverage area is greater than 90 degrees.

15. The computer program product of claim 11, wherein the instructions, when executed by the at least one processor, further cause the communication apparatus to further attempt to measure the reference signal by:
receiving synchronization signal block measurement timing configuration (STMCx) information, wherein the STMCx information comprises a periodicity of a measurement window or a duration of the measurement window; and
attempting, based on the STMCx information, to measure the reference signal.

16. The computer program product of claim 11, wherein the instructions, when executed by the at least one processor, further cause the communication apparatus to determine the location information using a global navigation satellite system (GNSS), and wherein the location information is an absolute location.

17. The computer program product of claim 11, wherein the instructions, when executed by the at least one processor, further cause the communication apparatus to receive, from the NTN device, a handover synchronization signal block (HO-SSB) after receiving the first configuration information from the TN device.

18. The computer program product of claim 11, wherein the instructions, when executed by the at least one processor, further cause the communication apparatus to use a random-access occasion (RO) resource associated with a handover synchronization signal block (HO-SSB) during a handover from the TN device to the NTN device.

19. The computer program product of claim 11, wherein the first configuration information further comprises the reference point in the first coverage area and a distance threshold of the first coverage area.

20. The computer program product of claim 11, wherein the instructions, when executed by the at least one processor, further cause the communication apparatus to send a measurement result to the NTN device after measuring the reference signal in the second coverage area of the NTN device, and wherein the measurement result comprises a reference signal received power (RSRP).
